(19) United States
(12) Patent Application Publication
(10) Pub. No.: US 2011/0292186 A1
(43) Pub. Date: Dec. 1, 2011

(54) IMAGE PROCESSING APPARATUS, IMAGE PROCESSING METHOD, AND IMAGE DISPLAY APPARATUS

(76) Inventors: Noritaka OKUDA, Tokyo (JP); Hirotaka Sakamoto, Tokyo (JP); Toshiaki Kubo, Tokyo (JP); Yoshiki Ono, Tokyo (JP); Satoshi Yamanaka, Tokyo (JP)

(21) Appl. No.: 13/114,219

(22) Filed: May 24, 2011

(30) Foreign Application Priority Data
May 25, 2010 (JP) 2010-119441
May 28, 2010 (JP) 2010-122923
May 28, 2010 (JP) 2010-122924
Mar. 10, 2011 (JP) 2011-053211

(51) Int. Cl. H04N 13/04; H04N 13/00

(52) U.S. Cl. 348/51; 348/42; 348/E13.001; 348/E13.075

(57) ABSTRACT

An image processing apparatus includes components explained below. A parallax calculating unit receives input of image input data Da1 and Db1, calculates a parallax amount in each of a plurality of divided regions, and outputs a plurality of parallax data T1. A frame-parallax calculating unit outputs, based on the parallax data T1 in a projecting direction, frame parallax data T2. A frame-parallax correcting unit outputs frame parallax data after correction T3 using the frame parallax data T2 of a plurality of frames. A parallax-adjustment-amount calculating unit outputs, based on parallax adjustment information S1 and the frame parallax data after correction T3, parallax adjustment data T4. An adjusted-image generating unit outputs, based on the parallax adjustment data T4, image output data Da2 and Db2.

### BACKGROUND OF THE INVENTION

1. Field of the Invention

The present invention relates to an image processing apparatus, an image processing method, and an image display apparatus for generating, as a corrected image, a pair of input images forming a three-dimensional video.

2. Description of the Related Art

In recent years, as an image display technology for a viewer to simulatively obtain the sense of depth, there is a three-dimensional image display technology that makes use of the binocular parallax. In the three-dimensional image display technology that makes use of the binocular parallax, a video viewed by the left eye and a video viewed by the right eye in a three-dimensional space are separately shown to the left eye and the right eye of the viewer, whereby the viewer feels that the videos are three-dimensional.

As a technology for showing different videos to the left and right eyes of the viewer, there are various systems such as a system for temporally alternately switching an image for left eye and an image for right eye to display the images on a display and, at the same time, temporally separating the left and right fields of view using eyeglasses for controlling amounts of light respectively transmitted through the left and right lenses in synchronization with image switching timing, and a system for using, on the front surface of a display, a barrier and a lens for limiting a display angle of an image to show an image for left eye and an image for right eye respectively to the left and right eyes.

When a parallax is large in such a three-dimensional image display apparatus, a protrusion amount and a retraction amount increase and surprise can be given to the viewer. However, when the parallax is increased to be equal to or larger than a certain degree, images for the right eye and the left eye do not merge because of a merging limit, a double image is seen, and a three-dimensional view cannot be obtained. Therefore, a burden is imposed on the eyes of the viewer.

As measures against this problem, Japanese Patent Application Laid-open No. 2008-306739 discloses a technology for, when it is determined based on information concerning a parallax embedded in a three-dimensional video that a display time of a three-dimensional image exceeds a predetermined time, changing a parallax of the three-dimensional image to thereby reduce a burden on the eyes of a viewer to reduce the fatigue of the eyes of the viewer.

However, the technology disclosed in Japanese Patent Application Laid-open No. 2008-306739 is not applicable when parallax information is not embedded in a three-dimensional video. Further, in changing the parallax of the three-dimensional image when the display time of the three-dimensional image exceeds the predetermined time, individual conditions such as a distance from a display surface to the viewer and the size of the display surface are not taken into account.

### SUMMARY OF THE INVENTION

It is an object of the present invention to at least partially solve the problems in the conventional technology.

In order to solve the aforementioned problems, an image processing apparatus according to one aspect of the present invention is constructed in such a manner as to include: a parallax calculating unit that receives input of a pair of image input data forming a three-dimensional video, divides the pair of image input data into a plurality of regions, calculates a parallax amount corresponding to each of the regions, and outputs the parallax amount as parallax data corresponding to each of the regions; a frame-parallax calculating unit that generates, based on a plurality of the parallax data, frame parallax data and outputs the frame parallax data; a frame-parallax correcting unit that corrects frame parallax data of one frame based on frame parallax data of other frames and outputs the frame parallax data as frame parallax data after correction; a parallax-adjustment-amount calculating unit that generates, based on parallax adjustment information created based on information indicating a situation of viewing and the frame parallax data after correction, parallax adjustment data and outputs the parallax adjustment data; and an adjusted-image generating unit that generates a pair of image output data, a parallax amount of which is adjusted based on the parallax adjustment data, and outputs the image output data.

Further, an image display unit according to another aspect of the present invention includes a display unit in addition to the image processing apparatus. The display unit displays a pair of image output data generated by the adjusted-image generating unit.

Still further, an image processing method according to further aspect of the present invention includes the steps of: receiving input of a pair of image input data forming a three-dimensional video, dividing the pair of image input data into a plurality of regions, calculating a parallax amount corresponding to each of the regions, and outputting the parallax amount as parallax data corresponding to each of the regions; generating, based on the parallax data, frame parallax data and outputting the frame parallax data; correcting frame parallax data of one frame based on frame parallax data of other frames, generating frame parallax data after correction, and outputting the frame parallax data after correction; generating, based on parallax adjustment information created based on information indicating a situation of viewing and the frame parallax data after correction, parallax adjustment data and outputting the parallax adjustment data; and generating a pair of image output data, a parallax amount of which is adjusted based on the parallax adjustment data, and outputting the image output data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of the configuration of an image display apparatus according to a first embodiment of the present invention;

FIG. 2 is a diagram for explaining a method in which a parallax calculating unit of an image processing apparatus according to the first embodiment of the present invention calculates parallax data;

FIG. 3 is a diagram of the detailed configuration of the parallax calculating unit of the image processing apparatus according to the first embodiment of the present invention;

FIG. 4 is a diagram for explaining a method in which a region-parallax calculating unit of the image processing apparatus according to the first embodiment of the present invention calculates parallax data;

FIG. 5 is a diagram for explaining in detail parallax data input to a frame-parallax calculating unit of the image processing apparatus according to the first embodiment of the present invention;

FIG. 6 is a diagram for explaining a method of calculating data of a frame parallax from parallax data of the image processing apparatus according to the first embodiment of the present invention;

FIG. 7 is a diagram for explaining in detail frame parallax data after correction calculated from the frame parallax data of the image processing apparatus according to the first embodiment of the present invention;

FIG. 8 is a diagram for explaining a change in a projection amount due to changes in a parallax amount of image input data and a parallax amount of image output data of the image display apparatus according to the first embodiment of the present invention;

FIG. 9 is a diagram for explaining a specific example of an image having a parallax of the image display apparatus according to the first embodiment of the present invention;

FIG. 10 is a diagram for explaining calculation of a parallax from image input data for left eye and image input data for right eye of the image processing apparatus according to the first embodiment of the present invention;

FIG. 11 is a diagram of parallaxes output by the parallax calculating unit of the image processing apparatus according to the first embodiment of the present invention;

FIG. 12 is a diagram for explaining calculation of frame parallax data from parallax data of the image processing apparatus according to the first embodiment of the present invention;

FIG. 13 is a diagram of a temporal change of the frame parallax data output by the frame-parallax calculating unit of the image processing apparatus according to the first embodiment of the present invention;

FIG. 14 is a diagram for explaining calculation of frame parallax data after correction from the frame parallax data of the image processing apparatus according to the first embodiment of the present invention;

FIGS. 15A and 15B are diagrams for explaining calculation of parallax adjustment data from the frame parallax data after correction of the image processing apparatus according to the first embodiment of the present invention;

FIG. 16 is a diagram for explaining calculation of image output data from the parallax adjustment data and image input data of the image display apparatus according to the first embodiment of the present invention;

FIG. 17 is a flowchart for explaining a flow of a three-dimensional image processing method according to a second embodiment of the present invention of an image processing apparatus according to the second embodiment of the present invention;

FIG. 18 is a flowchart for explaining a flow of a parallax calculating step of the image processing apparatus according to the second embodiment of the present invention;

FIG. 19 is a flowchart for explaining a flow of a frame parallax correcting step of the image processing apparatus according to the second embodiment of the present invention;

FIG. 20 is a diagram of the configuration of a three-dimensional image display apparatus according to a third embodiment of the present invention;

FIG. 21 is a diagram for explaining in detail parallax data input to a frame-parallax calculating unit of an image processing apparatus according to the third embodiment of the present invention;

FIG. 22 is a diagram for explaining a method of calculating first frame parallax data and second frame parallax data from parallax data of the image processing apparatus according to the third embodiment of the present invention;

FIG. 23 is a diagram for explaining in detail first frame parallax data after correction and second frame parallax data after correction calculated from the first frame parallax data and the second frame parallax data of the image processing apparatus according to the third embodiment of the present invention;

FIG. 24 is a diagram for explaining a specific example of an image having a parallax of an image display apparatus according to the third embodiment of the present invention;

FIG. 25 is a diagram for explaining calculation of a parallax from image input data for left eye and image input data for right eye of the image processing apparatus according to the third embodiment of the present invention;

FIG. 26 is a diagram for explaining calculation of a parallax from the image input data for left eye and the image input data for right eye of the image processing apparatus according to the third embodiment of the present invention;

FIG. 27 is a diagram of parallaxes output by a parallax calculating unit of the image processing apparatus according to the third embodiment of the present invention;

FIG. 28 is a diagram for explaining calculation of first frame parallax data and second frame parallax data from parallax data of the image processing apparatus according to the third embodiment of the present invention;

FIG. 29 is a diagram of temporal changes of the first frame parallax data and the second frame parallax data output by the frame-parallax calculating unit of the image processing apparatus according to the third embodiment of the present invention;

FIG. 30 is a diagram for explaining calculation of first frame parallax data after correction from the first frame parallax data and calculation of second frame parallax data after correction from the second frame parallax data of the image processing apparatus according to the third embodiment of the present invention;

FIGS. 31A and 31B are diagrams for explaining calculation of intermediate parallax adjustment data and parallax adjustment data from the first frame parallax data after correction and the second frame parallax data after correction of the image processing apparatus according to the third embodiment of the present invention;

FIG. 32 is a diagram for explaining calculation of image output data from the parallax adjustment data and image input data of the image display apparatus according to the third embodiment of the present invention;

FIG. 33 is a schematic diagram of the configuration of an image processing apparatus according to a fifth embodiment of the present invention;

FIG. 34 is a diagram for explaining an image reducing unit of the image processing apparatus according to the fifth embodiment of the present invention;

FIG. 35 is a diagram for explaining a method in which a parallax calculating unit 1 of the image processing apparatus according to the fifth embodiment of the present invention calculates, based on image data for left eye Da3 and image data for right eye Db3, parallax data T1;

FIG. 36 is a schematic diagram of the detailed configuration of the parallax calculating unit 1 of the image processing apparatus according to the fifth embodiment of the present invention;

FIG. 37 is a diagram for explaining in detail frame parallax data after correction T3 calculated from frame parallax data T2 of the image processing apparatus according to the fifth embodiment of the present invention;

FIG. 38 is a diagram for explaining a change in a projection amount due to changes in a parallax amount between image input data Da0 and Db0 and a parallax amount between image output data Da2 and Db2 of the image processing apparatus according to the fifth embodiment of the present invention;

FIG. 39 is a diagram for explaining generation of reduced image data for left eye Da3 and image data for right eye Db3 from image input data for left eye Da1 and image input data for right eye Db1 of the image processing apparatus according to the fifth embodiment of the present invention;

FIG. 40 is a diagram for explaining calculation of a parallax from the image data for left eye Da3 and the image data for right eye Db3 of the image processing apparatus according to the fifth embodiment of the present invention;

FIG. 41 is a diagram for explaining calculation of a parallax from the image data for left eye Da3 and the image data for right eye Db3 of the image processing apparatus according to the fifth embodiment of the present invention;

FIG. 42 is a schematic diagram of a temporal change of the frame parallax data T2 output by a frame-parallax calculating unit 2 of the image processing apparatus according to the fifth embodiment of the present invention;

FIG. 43 is a diagram for explaining calculation of the frame parallax data after correction T3 from the frame parallax data T2 of the image processing apparatus according to the fifth embodiment of the present invention;

FIGS. 44A and 44B are diagrams for explaining calculation of parallax adjustment data T4 from the frame parallax data after correction T3 of the image processing apparatus according to the fifth embodiment of the present invention; and

FIG. 45 is a flowchart for explaining an image processing method according to a sixth embodiment of the present invention.

### DETAILED DESCRIPTION OF THE PREFERRED EMBODIMENTS

### First Embodiment

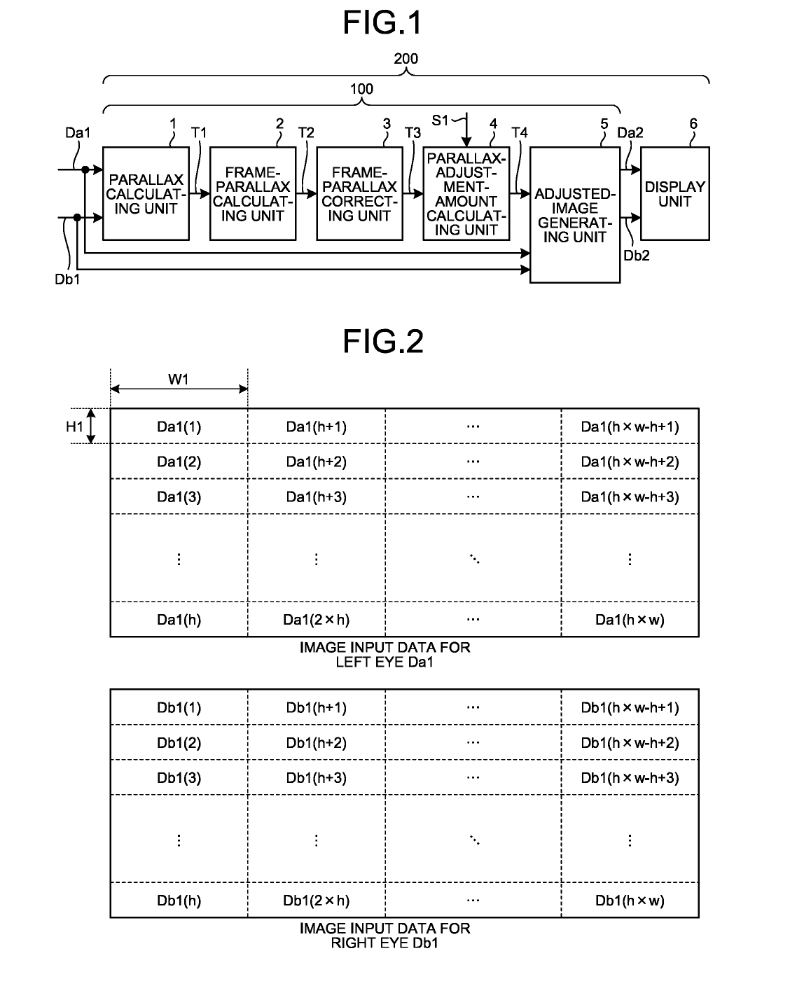

FIG. 1 is a diagram of the configuration of an image display apparatus 200 that displays a three-dimensional image according to a first embodiment of the present invention. The image display apparatus 200 according to the first embodiment includes a parallax calculating unit 1, a frame-parallax calculating unit 2, a frame-parallax correcting unit 3, a parallax-adjustment-amount calculating unit 4, an adjusted-image generating unit 5, and a display unit 6. An image processing apparatus 100 in the image display apparatus 200 includes the parallax calculating unit 1, the frame-parallax calculating unit 2, the frame-parallax correcting unit 3, the parallax-adjustment-amount calculating unit 4, and the adjusted-image generating unit 5.

Image input data for left eye Da1 and image input data for right eye Db1 are input to the parallax calculating unit 1 and the adjusted-image generating unit 5. The parallax calculating unit 1 calculates, based on the image input data for left eye Da1 and the image input data for right eye Db1, a parallax amount in each of regions and outputs parallax data T1. The parallax data T1 is input to the frame-parallax calculating unit 2.

The frame-parallax calculating unit 2 calculates, based on the parallax data T1, a parallax amount for a focused frame (hereinafter may be referred to just as a “frame of attention”) and outputs the parallax amount as frame parallax data T2. The frame parallax data T2 is input to the frame-parallax correcting unit 3.

After correcting the frame parallax data T2 of the frame of attention referring to the frame parallax data T2 of frames at other hours, the frame-parallax correcting unit 3 outputs frame parallax data after correction T3. The frame parallax data after correction T3 is input to the parallax-adjustment-amount calculating unit 4.

The parallax-adjustment-amount calculating unit 4 outputs parallax adjustment data T4 calculated based on parallax adjustment information S1 input by a viewer 9 and the frame parallax data after correction T3. The parallax adjustment data T4 is input to the adjusted-image generating unit 5.

The adjusted-image generating unit 5 outputs image output data for left eye Da2 and image output data for right eye Db2 obtained by adjusting, based on the parallax adjustment data T4, a parallax amount between the image input data for left eye Da1 and the image input data for right eye Db1. The image output data for left eye Da2 and the image output data for right eye Db2 are input to the display unit 6. The display unit 6 displays the image output data for left eye Da2 and the image output data for right eye Db2 on a display surface.

The detailed operations of the image processing apparatus 100 according to the first embodiment of the present invention are explained below.

FIG. 2 is a diagram for explaining a method in which the parallax calculating unit 1 calculates, based on the image input data for left eye Da1 and the image input data for right eye Db1, the parallax data T1.

The parallax calculating unit 1 divides the image input data for left eye Da1 and the image input data for right eye Db1, which are input data, to correspond to the size of regions sectioned in width W1 and height H1 on a display surface and calculates a parallax amount in each of the regions. A three-dimensional video is a moving image formed by continuous pairs of images for left eye and images for right eye. The image input data for left eye Da1 is an image for left eye and the image input data for right eye Db1 is an image for right eye. Therefore, the images themselves of the video are the image input data for left eye Da1 and the image input data for right eye Db1. For example, when the image processing apparatus 100 according to the first embodiment is applied to a television, a decoder decodes a broadcast signal. A video signal obtained by the decoding is input as the image input data for left eye Da1 and the image input data for right eye Db1. The number of divisions of a screen is determined, when the image processing apparatus 100 according to the first embodiment is implemented in an actual LSI or the like, taking into account a processing amount or the like of the LSI.

The number of regions in the vertical direction of the regions sectioned on the display surface is represented as a positive integer h and the number of regions in the horizontal direction is represented as a positive integer w. In FIG. 2, a number of a region at the most upper left is 1 and subsequent regions are numbered 2 and 3 to h×w from up to down in the left column and from the left column to the right column. Image data included in the first region of the image input data for left eye Da1 is represented as Da1(1) and image data included in the subsequent regions are represented as Db1(2) and Da1(3) to Da1(h×w). Similarly, image data included in the regions of the image input data for right eye Db1 are represented as Db1(1), Db1(2), and Db1(3) to Db1(h×w).

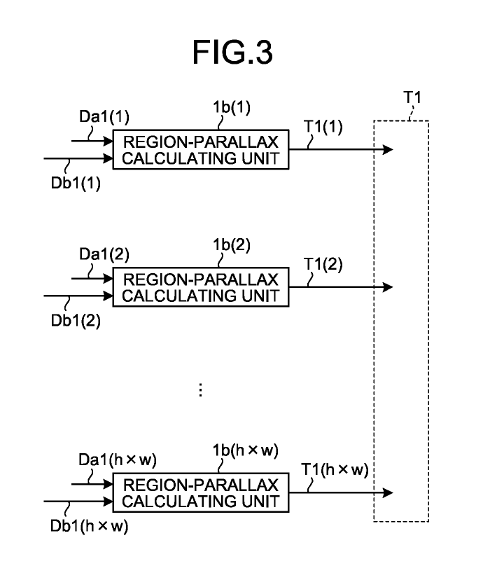

FIG. 3 is a diagram of the detailed configuration of the parallax calculating unit 1. The parallax calculating unit 1 includes h×w region-parallax calculating units 1b to calculate a parallax amount in each of the regions. A region-parallax calculating unit 1b(1) calculates, based on the image input data for left eye Da1(1) and the image input data for right eye Db1(1) included in the first region, a parallax amount in the first region and outputs the parallax amount as parallax data T1(1) of the first region. Similarly, region-parallax calculating units 1b(2) to 1b(h×w) respectively calculate parallax amounts in the second to h×w-th regions and output the parallax amounts as parallax data T1(2) to T1(h×w) of the second to h×w-th regions. The parallax calculating unit 1 outputs the parallax data T1(1) to T1(h×w) of the first to h×w-th regions as the parallax data T1.

The region-parallax calculating unit 1b(1) calculates, using a phase limiting correlation method, the parallax data T1(1) between the image input data for left eye Da1(1) and the image input data for right eye Db1(1). The phase limiting correlation method is explained in, for example, Non-Patent Literature (Mizuki Hagiwara and Masayuki Kawamata “Misregistration Detection at Sub-pixel Accuracy of Images Using a Phase Limiting Function”, the Institute of Electronics, Information and Communication Engineers Technical Research Report, No. CAS2001-11, VLD2001-28, DSP2001-30, June 2001, pp. 79 to 86). The phase limiting correlation method is an algorithm for receiving a pair of images of a three-dimensional video as an input and outputting a parallax amount.

The following Formula (1) is a formula representing a parallax amount Nopt calculated by the phase limiting correlation method. In Formula (1), Gab(n) represents a phase limiting correlation function.

Nₒₚₜ=argmax(G_{ab}(n)) (1)

where, n represents a range of 0≦n≦W1 and argmax(G_{ab}(n)) is a value of n at which G_{ab}(n) is the maximum. When G_{ab}(n) is the maximum, n is Nₒₚₜ. G_{ab}(n) is represented by the following Formula (2):

$${G}_{ab} ( n ) = IFFT ( \frac{{F}_{ab} ( n )}{\vert {F}_{ab} ( n ) \vert} ) \qquad ( 2 )$$

where, a function IFFT is an inverse fast Fourier transform function and |F_{ab}(n)| is the magnitude of F_{ab} (n). F_{ab} (n) is represented by the following Formula (3):

F_{ab}(n)=A·B*(n) (3)

where, B*(n) represents a sequence of a complex conjugate of B(n) and A·B*(n) represents a convolution of A and B*(n). A and B(n) are represented by the following Formula (4):

A=FFT(a(m)), B(n)=FFT(b)(m−n)) (4)

where, a function FFT is a fast Fourier transform function, a(m) and b(m) represent continuous one-dimensional sequences, m represents an index of a sequence, b(m) is equal to a(m−τ) (b(m)=a(m−τ)), i.e., b(m) is a sequence obtained by shifting a(m) to the right by τ, and b(m−n) is a sequence obtained by shifting b(m) to the right by n.

In the region-parallax calculating unit 1b, Nₒₚₜ calculated by the phase limiting correlation method with the image input data for left eye Da1(1) set as “a” of Formula (4) and the image input data for right eye Db1(1) set as “b” of Formula (4) is the parallax data T1(1).

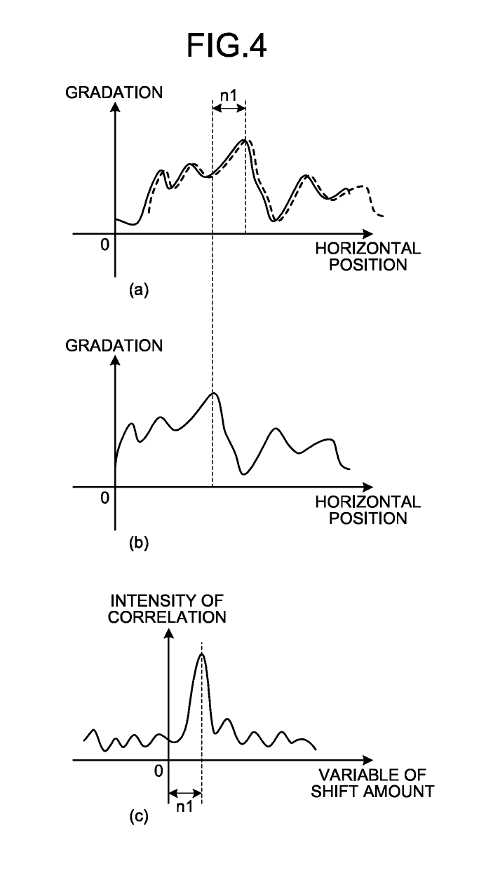

FIG. 4 is a diagram for explaining a method of calculating the parallax data T1(1) from the image input data for left eye Da1(1) and the image input data for right eye Db1(1) included in the first region using the phase limiting correlation method. A graph represented by a solid line of FIG. 4(a) is the image input data for left eye Da1(1) corresponding to the first region. The abscissa indicates a horizontal position and the ordinate indicates a gradation. A graph of FIG. 4(b) is the image input data for right eye Db1(1) corresponding to the first region. The abscissa indicates a horizontal position and the ordinate indicates a gradation. A characteristic curve represented by a broken line of FIG. 4(a) is a characteristic curve obtained by shifting a characteristic curve of the image input data for right eye Db1(1) shown in FIG. 4(b) by a parallax amount n1 of the first region. A graph of FIG. 4(c) is the phase limiting correlation function G_{ab}(n). The abscissa indicates a variable n of G_{ab}(n) and the ordinate indicates the intensity of correlation.

The phase limiting correlation function G_{ab}(n) is defined by a sequence “a” and a sequence “b” obtained by shifting “a” by τ, which are continuous sequences. The phase limiting correlation function G_{ab}(n) is a delta function having a peak at n=−τ according to Formulas (2) and (3). When the image input data for right eye Db1(1) projects with respect to the image input data for left eye Da1(1), the image input data for right eye Db1(1) shifts in the left direction. When the image input data for right eye Db1(1) retracts with respect to the image input data for left eye Da1(1), the image input data for right eye Db1(1) shifts in the right direction. Data obtained by dividing the image input data for left eye Da1(1) and the image input data for right eye Db1(1) into regions is highly likely to shift in at least one of the projecting direction and the retracting direction. Nₒₚₜ of Formula (1) calculated with the image input data for left eye Da1(1) and the image input data for right eye Db1(1) set as the inputs a(m) and b(m) of Formula (4) is the parallax data T1(1).

In this embodiment, the parallax data T1 is a value having a sign. The parallax data T1 corresponding to a parallax in a projecting direction between an image for right eye and an image for left eye corresponding to each other is positive. The parallax data T1 corresponding to a parallax in a retracting direction between the image for right eye and the image for left eye corresponding to each other is negative. When there is no parallax between the image for right eye and the image for left eye corresponding to each other, the parallax data T1 is zero.

A shift amount is n1 according to a relation between FIGS. 4(a) and 4(b). Therefore, when the variable n of a shift amount concerning the phase limiting correlation function G_{ab}(n) is n1 as shown in FIG. 4(c), a value of a correlation function is the maximum.

The region-parallax calculating unit 1b(1) outputs, as the parallax data T1(1), the shift amount n1 at which a value of the phase limiting correlation function G_{ab}(n) with respect to the image input data for left eye Da1(1) and the image input data for right eye Db1(1) is the maximum according to Formula (1).

Similarly, when N is integers from 2 to h×w, the region-parallax calculating units 1b(N) output, as parallax data T1(N), shift amounts at which values of phase limiting correlations of image input data for left eye Da1(N) and image input data for right eye Db1(N) included in an N-th regions are the maximum.

Non-Patent Document 1 describes a method of directly receiving the image input data for left eye Da1 and the image input data for right eye Db1 as inputs and obtaining a parallax amount between the image input data for left eye Da1 and the image input data for right eye Db1. However, as an input image is larger, computational complexity increases. When the method is implemented in an LSI, a circuit size is made large. Further, the peak of the phase limiting correlation function G_{ab}(n) with respect to an object captured small in the image input data for left eye Da1 and the image input data for right eye Db1 is small. Therefore, it is made difficult to calculate a parallax amount of the object captured small.

The parallax calculating unit 1 of the image processing apparatus 100 according to the first embodiment divides the image input data for left eye Da1 and the image input data for right eye Db1 into small regions and applies the phase limiting correlation method to each of the regions. Therefore, the phase limiting correlation method can be implemented in an LSI in a small circuit size. In this case, the circuit size can be further reduced by calculating parallax amounts for the respective regions in order using one circuit rather than simultaneously calculating parallax amounts for all the regions. In the divided small regions, the object captured small in the image input data for left eye Da1 and the image input data for right eye Db1 occupies a relatively large region. Therefore, the peak of the phase limiting correlation function G_{ab}(n) is large and can be easily detected. Therefore, a parallax amount can be calculated more accurately. The frame-parallax calculating unit 2 explained below outputs, based on the parallax amounts calculated for the respective regions, a parallax amount in the entire image between the image input data for left eye Da1 and the image input data for right eye Db1.

The detailed operations of the frame-parallax calculating unit 2 are explained below.

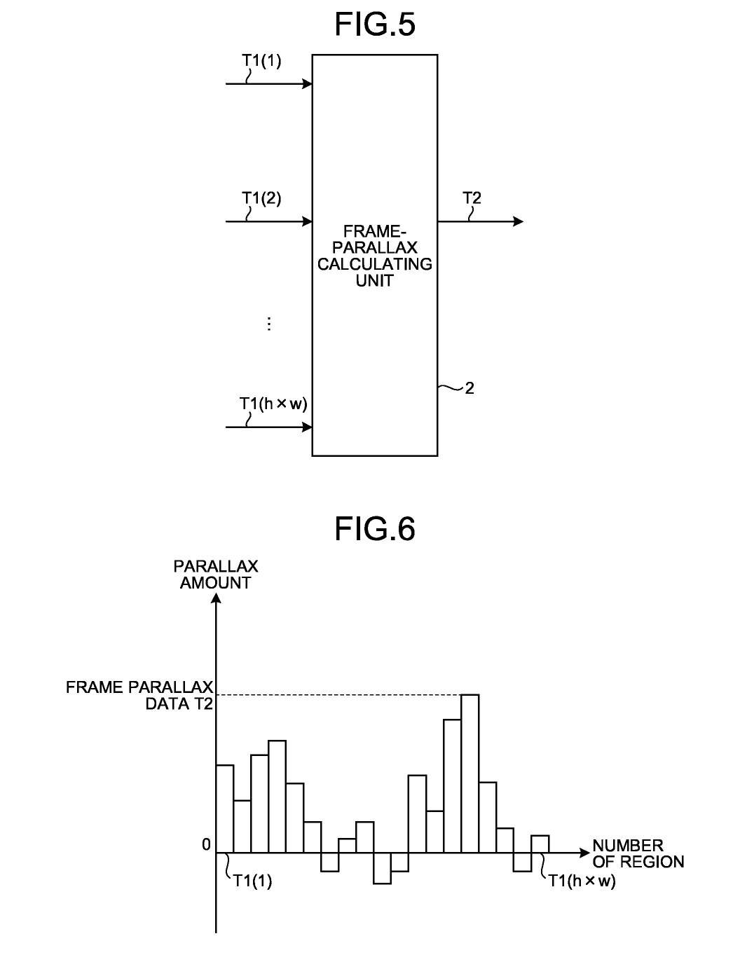

FIG. 5 is a diagram for explaining in detail the parallax data T1 input to the frame-parallax calculating unit 2. The frame-parallax calculating unit 2 aggregates the input parallax data T1(1) to T1(h×w) corresponding to the first to h×w-th regions and calculates one frame parallax data T2 with respect to an image of the frame of attention.

FIG. 6 is a diagram for explaining a method of calculating, based on the parallax data T1(1) to T1(h×w), the frame parallax data T2. The abscissa indicates a number of a region and the ordinate indicates parallax data T1 (a parallax amount). The frame-parallax calculating unit 2 outputs maximum parallax data T1 among the parallax data T1(1) to T1(h×w) as the frame parallax data T2 of a frame image.

Consequently, concerning a three-dimensional video not embedded with parallax information, it is possible to calculate a parallax amount in a section projected most in frames of the three-dimensional video considered to have the largest influence on the viewer 9.

The detailed operations of the frame-parallax correcting unit 3 are explained below.

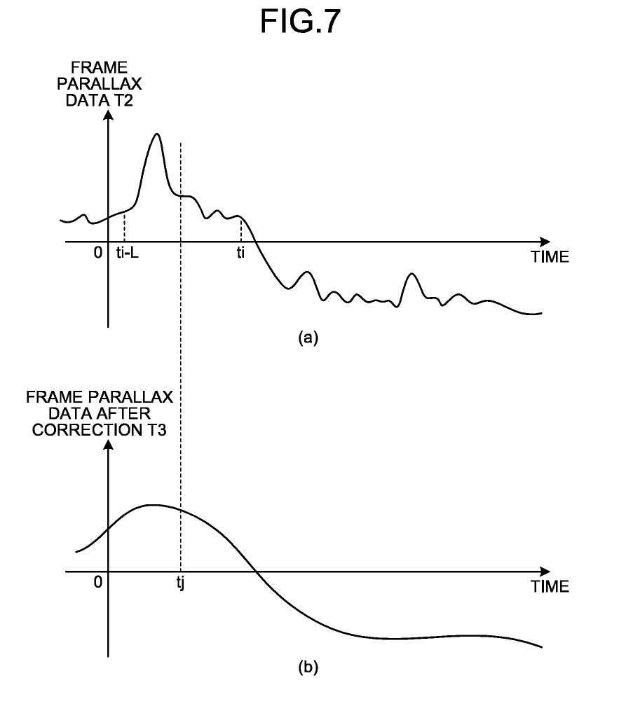

FIG. 7 is a diagram for explaining in detail the frame parallax data after correction T3 calculated from the frame parallax data T2. FIG. 7(a) is a diagram of a temporal change of the frame parallax data T2. The abscissa indicates time and the ordinate indicates the frame parallax data T2. FIG. 7(b) is a diagram of a temporal change of the frame parallax data after correction T3. The abscissa indicates time and the ordinate indicates the frame parallax data after correction T3.

The frame-parallax correcting unit 3 stores the frame parallax data T2 for a fixed time, calculates an average of a plurality of the frame parallax data T2 before and after the frame of attention, and outputs the average as the frame parallax data after correction T3. The frame parallax data after correction T3 is represented by the following Formula (5):

$$T 3 ( tj ) = \frac{{\sum }_{k = ti - L}^{ti} T 2 ( k )}{L} \qquad ( 5 )$$

where, T3(tj) represents frame parallax data after correction at an hour tj of attention, T2(k) represents the frame parallax data T3 at an hour k, and a positive integer L represents width for calculating an average. Because tj<ti, for example, the frame parallax data after correction T3 at the hour tj shown in FIG. 7(b) is calculated from an average of the frame parallax data T2 from an hour (ti−L) to an hour ti shown in FIG. 7(a). Because (ti−L)<tj<ti, for example, the frame parallax data after correction T3 at the hour tj shown in FIG. 7(b) is calculated from the average of the frame parallax data T2 from the hour (ti−L) to the hour ti shown in FIG. 7(a).

Most projection amounts of a three-dimensional video temporally continuously change. When the frame parallax data T2 temporally discontinuously changes, for example, when the frame parallax data T2 changes in an impulse shape with respect to a time axis, it can be regarded that misdetection of the frame parallax data T2 occurs. Because the frame-parallax correcting unit 3 can temporally average the frame parallax data T2 even if there is the change in the impulse shape, the misdetection can be eased.

The detailed operations of the parallax-adjustment-amount calculating unit 4 are explained below.

The parallax-adjustment-amount calculating unit 4 calculates, based on the parallax adjustment information S1 set by the viewer 9 according to a parallax amount, with which the viewer 9 can easily see an image, and the frame parallax data after correction T3, a parallax adjustment amount and outputs the parallax adjustment data T4.

The parallax adjustment information S1 includes a parallax adjustment coefficient S1a and a parallax adjustment threshold S1b. The parallax adjustment data T4 is represented by the following Formula (6):

$$T 4 = \{ \begin{matrix}0 & ( T 3 \leq S 1 b ) \\ S 1 a \times ( T 3 - S 1 b ) & ( T 3 > S 1 b )\end{matrix} \qquad ( 6 )$$

The parallax adjustment data T4 means a parallax amount for reducing a projection amount according to image adjustment. The parallax adjustment data T4 indicates amounts for horizontally shifting the image input data for left eye Da1 and the image input data for right eye Db1. As explained in detail later, a sum of the amounts for horizontally shifting the image input data for left eye Da1 and the image input data for right eye Db1 is the parallax adjustment data T4. Therefore, when the frame parallax data after correction T3 is equal to or smaller than the parallax adjustment threshold S1b, the image input data for left eye Da1 and the image input data for right eye Db1 are not shifted in the horizontal direction according to the image adjustment. On the other hand, when the frame parallax data after correction T3 is larger than the parallax adjustment threshold S1b, the image input data for left eye Da1 and the image input data for right eye Db1 are shifted in the horizontal direction by a value obtained by multiplying a difference between the frame parallax data after correction T3 and the parallax adjustment threshold S1b with the parallax adjustment coefficient S1a.

For example, in the case of the parallax adjustment coefficient S1a=1 and the parallax adjustment threshold S1b=0, T4=0 when T3≦0. In other words, the image adjustment is not performed. On the other hand, T4=T3 when T3>0. The image input data for left eye Da1 and the image input data for right eye Db1 are shifted in the horizontal direction by T3. Because the frame parallax data after correction T3 is a maximum parallax of a frame image, a maximum parallax calculated in the frame of attention is zero. When the parallax adjustment coefficient S1a is reduced to be smaller than 1, the parallax adjustment data T4 decreases to be smaller than the parallax data after correction T3 and the maximum parallax calculated in the frame of attention increases to be larger than zero. When the parallax adjustment threshold S1b is increased to be larger than zero, adjustment of the parallax data T1 is not applied to the frame parallax data after correction T3 having a value larger than zero. In other words, parallax adjustment is not applied to a frame in which an image is slightly projected.

For example, a user determines the setting of the parallax adjustment information S1 while changing the parallax adjustment information S1 with input means such as a remote controller and checking a change in a projection amount of the three-dimensional image. The user can also input the parallax adjustment information S1 from a parallax adjustment coefficient button and a parallax adjustment threshold button of the remote controller. However, predetermined parallax adjustment coefficients S1a and S1b and parallax adjustment threshold S1b can be set when the user inputs an adjustment degree of a parallax from one ranked parallax adjustment button.

The image display apparatus 200 can include a camera or the like for observing the viewer 9, discriminate the age of the viewer 9, the sex of the viewer 9, the distance from the display surface to the viewer 9, and the like, and automatically set the parallax adjustment information S1. In this case, the size of a display surface of the image display apparatus 200 and the like can be included in the parallax adjustment information S1. Only predetermined values of the size of the display surface of the image display apparatus 200 and the like can also be set as the parallax adjustment information S1. As explained above, information including personal information, the age of the viewer 9, and the sex of the viewer 9 input by the viewer 9 using the input means such as the remote controller, positional relation including the distance between the viewer 9 and the image display apparatus, and information related to a situation of viewing such as the size of the display surface of the image display apparatus is referred to as information indicating a situation of viewing.

Consequently, the image processing apparatus 100 according to this embodiment can display a three-dimensional image with a parallax amount between an input pair of images changed to a parallax for a sense of depth suitable for the viewer 9 corresponding to the distance from the display surface 61 to the viewer 9, a personal difference of the viewer 9, and the like.

The operation of the adjusted-image generating unit 5 is explained below.

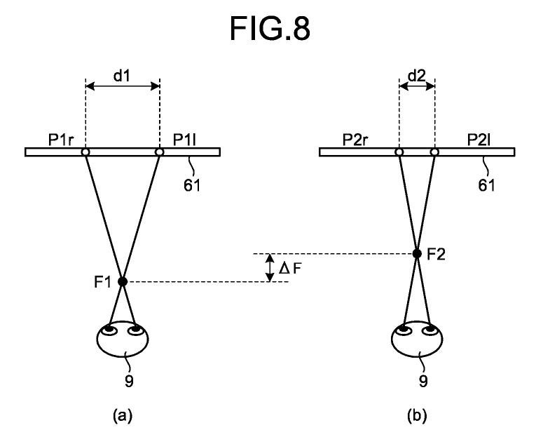

FIG. 8 is a diagram for explaining a relation between a parallax amount between the image input data for left eye Da1 and the image input data for right eye Db1 and a projection amount of an image. FIG. 8 is a diagram for explaining a relation between a parallax amount between the image output data for left eye Da2 and the image output data for right eye Db2 and a projection amount of an image. FIG. 8(a) is a diagram of the relation between the parallax amount between the image input data for left eye Da1 and the image input data for right eye Db1 and the projection amount of the image. FIG. 8(b) is a diagram of the relation between the parallax amount between the image output data for left eye Da2 and the image output data for right eye Db2 and the projection amount of the image.

When the adjusted-image generating unit 5 determines that T3>S1b based on the parallax adjustment data T4, the adjusted-image generating unit 5 outputs the image output data for left eye Da2 obtained by horizontally shifting the image input data for left eye Da1 in the left direction based on the parallax adjustment data T4 and the image output data for right eye Db2 obtained by horizontally shifting the image input data for right eye Db1 in the right direction based on the parallax adjustment data T4. At this point, a parallax amount d2 is calculated by d2=d1−T4 using the parallax amount d1 and the parallax adjustment data T4.

When a pixel P1l of the image input data for left eye Da1 and a pixel P1r of the image input data for right eye Db1 are assumed to be the same part of the same object, a parallax between the pixels P1l and P1r is d1. The viewer 9 can see the object in a state in which the object projects to a position F1.

When a pixel P21 of the image output data for left eye Da2 and a pixel P2r of the image output data for right eye Db2 are assumed to be the same part of the same object, a parallax amount between the pixels P21 and P2r is d2. The viewer 9 can see the object in a state in which the object projects to a position F2.

The image input data for left eye Da1 is horizontally shifted in the left direction and the image input data for right eye Db1 is horizontally shifted in the right direction, whereby the parallax amount d1 decreases to the parallax amount d2. Therefore, the projected position changes from F1 to F2. An amount of change is ΔF.

The frame parallax data after correction T3 is calculated from the frame parallax data T2, which is the maximum parallax data of a frame image. Therefore, the frame parallax data after correction T3 is the maximum parallax data of the frame image. The parallax adjustment data T4 is calculated based on the frame parallax data after correction T3 according to Formula (6). Therefore, when the parallax adjustment coefficient S1a is 1, the parallax adjustment data T4 is equal to the maximum parallax amount in the frame of attention. When the parallax adjustment coefficient S1a is smaller than 1, the parallax adjustment data T4 is smaller than the maximum parallax amount. When it is assumed that the parallax amount d1 shown in FIG. 8(a) is the maximum parallax amount calculated in the frame of attention, the maximum parallax d2 after adjustment shown in FIG. 8(b) is a value smaller than the parallax amount d1 when the parallax adjustment coefficient S1a is set smaller than 1. When the parallax adjustment coefficient S1a is set to 1 and the parallax adjustment threshold S1b is set to 0, a video is an image that is not projected and the parallax amount d2 is 0. Consequently, the maximum projected position F2 of the image data after adjustment is adjusted to a position between the display surface 61 and the projected position F1.

The operation of the display unit 6 is explained below. The display unit 6 displays the image output data for left eye Da2 and the image output data for right eye Db2 separately on the left eye and the right eye of the viewer 9. Specifically, a display system can be a three-dimensional image display system employing a display that can display different images on the left eye and the right eye with an optical mechanism such as a barrier or a lens that limits a display angle. The display system can also be a three-dimensional image display system employing dedicated eyeglasses that close shutters of lenses for the left eye and the right eye in synchronization with a display that alternately displays an image for left eye and an image for right eye.

The detailed operations of the image display apparatus 200 that displays a three-dimensional image according to the first embodiment of the present invention are explained above.

The first embodiment is explained below based on a specific image example.

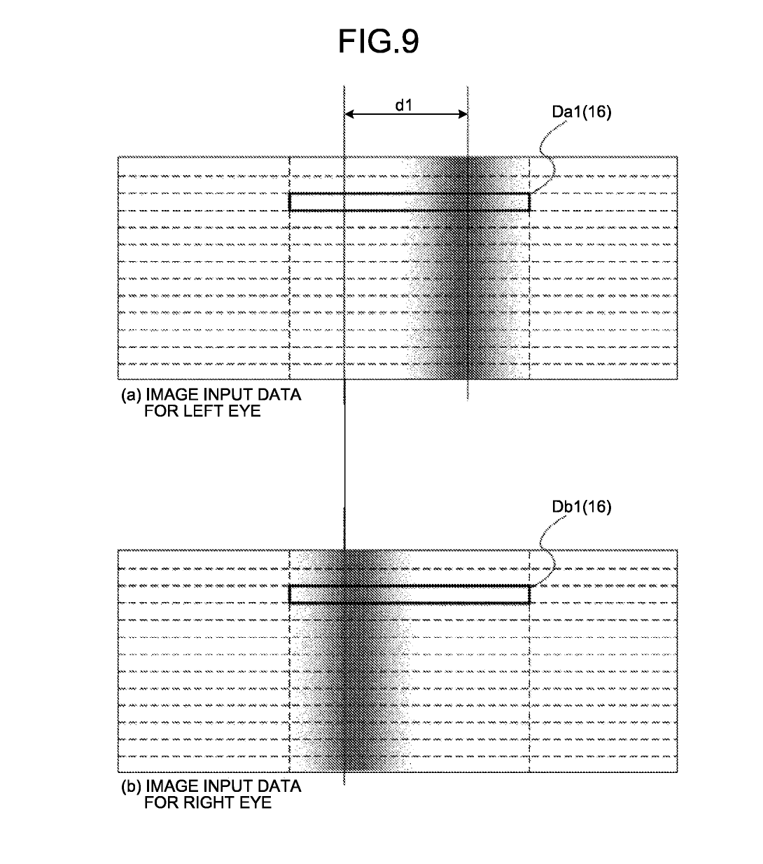

FIG. 9 is a diagram of a specific example of the image input data for left eye Da1 and the image input data for right eye Db1. FIG. 9(a) is a diagram of the entire image input data for left eye Da1. FIG. 9(b) is a diagram of the entire image input data for right eye Db1. There is a parallax of a parallax amount d1 in the horizontal direction between the image input data for left eye Da1 and the image input data for right eye Db1. Boundaries for sectioning the image input data for left eye Da1 and the image input data for right eye Db1 into regions for calculating a parallax amount are indicated by broken lines. Each of the image input data for left eye Da1 and the image input data for right eye Db1 is divided into, in order from a region at the most upper left, a first region, a second region, and a third region to a thirty-ninth region at the most lower right. Image input data for left eye Da1(16) and image input data for right eye Db1(16) in a sixteenth region are indicated by thick solid lines.

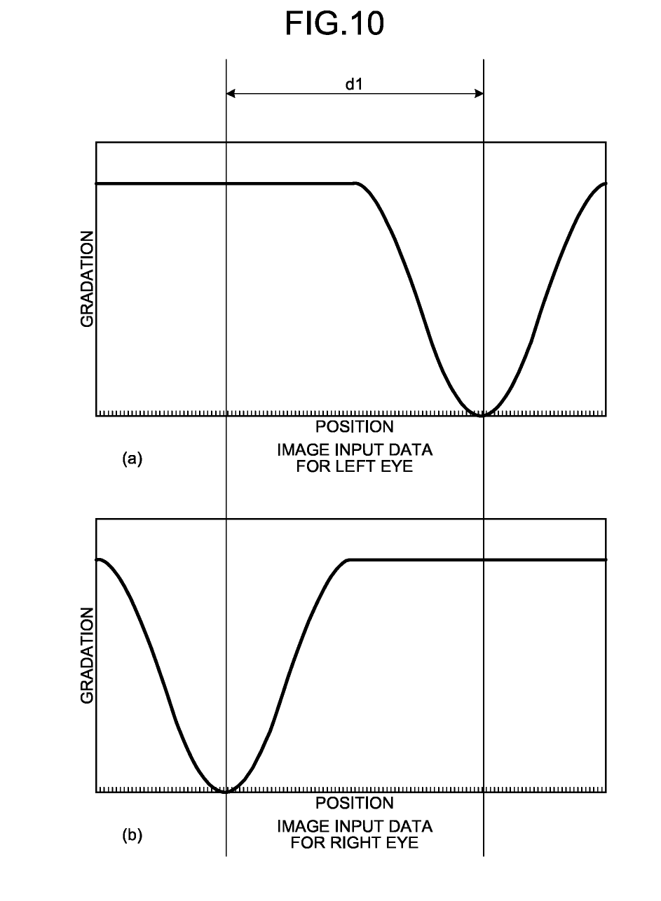

FIG. 10 is a diagram for explaining a method of calculating a parallax amount from the image input data for left eye Da1(16) and the image input data for right eye Db1(16). FIG. 10(a) is a diagram of a relation between a horizontal position and a gradation of the image input data for left eye Da1(16). FIG. 10(b) is a diagram of a relation between a horizontal position and a gradation of the image input data for right eye Db1(16). The abscissa indicates the horizontal position and the ordinate indicates the gradation.

Both the image input data for left eye Da1(16) and the image input data for right eye Db1(16) are represented as graphs including regions that change in a convex trough shape in a direction in which the gradation decreases (a down direction in FIG. 10). Positions of minimum values of the image input data for left eye Da1(16) and the image input data for right eye Db1(16) shift exactly by the parallax amount d1. The image input data for left eye Da1(16) and the image input data for right eye Db1(16) are input to a region-parallax calculating unit 1b(16) of the parallax calculating unit 1. The parallax amount d1 is output as parallax data T1(16) of the sixteenth region.

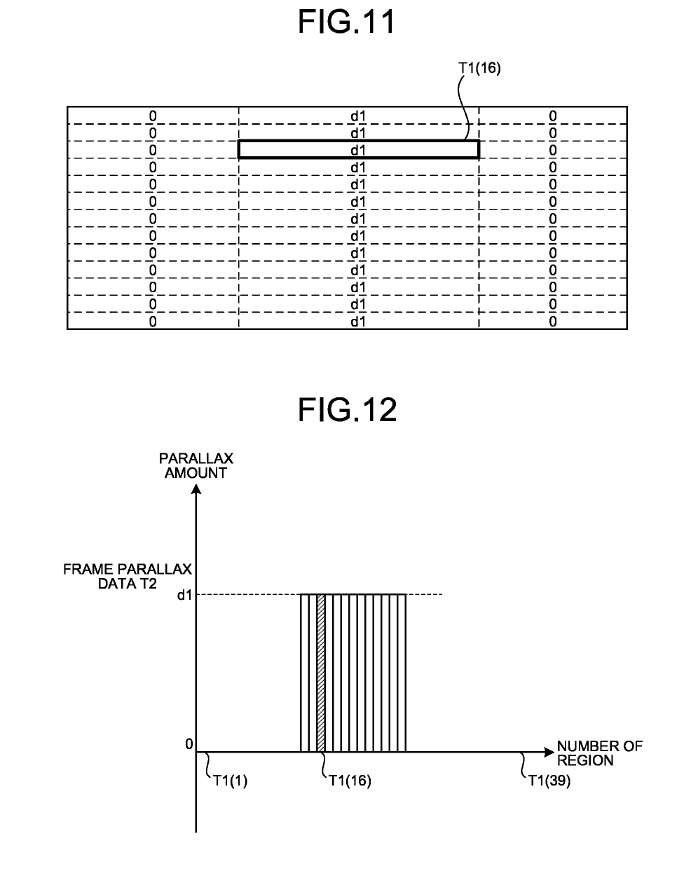

FIG. 11 is a diagram of the parallax data T1 output from the parallax calculating unit 1. Values of the parallax data T1(1) to parallax data T1(39) output by the region-parallax calculating unit 1b(1) to a region-parallax calculating unit 1b(39) are shown in regions sectioned by broken lines.

FIG. 12 is a diagram for explaining a method of calculating the frame parallax data T2 from the parallax data T1. The abscissa indicates numbers of regions and the ordinate indicates the parallax data T1 (a parallax amount).

A hatched bar graph indicates the parallax data T1(16) of the sixteenth region. The frame-parallax calculating unit 2 compares the parallax data T1 input from the parallax calculating unit 1 and outputs the parallax amount d1, which is the maximum value, as the frame parallax data T2.

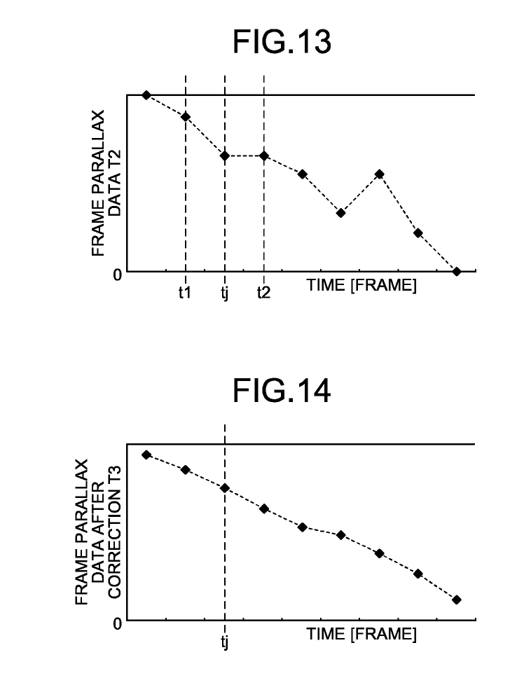

FIG. 13 is a diagram of a temporal change of the frame parallax data T2 output by the frame-parallax calculating unit 2. The abscissa indicates time and the ordinate indicates the frame parallax data T2. The image shown in FIG. 9 is a frame at the hour tj.

FIG. 14 is a diagram for explaining a method of calculating the frame parallax data after correction T3 from the frame parallax data T2. A temporal change of the frame parallax data after correction T3 is shown in FIG. 14. The abscissa indicates time and the ordinate indicates the frame parallax data after correction T3. The image shown in FIG. 9 is a frame at the hour tj. Width L for calculating an average of the frame parallax data T2 is set to 3. The frame-parallax correcting unit 3 averages the frame parallax data T2 between the frame of attention and frames before and after the frame of attention using the Formula (5). The frame-parallax correcting unit 3 outputs an average of the frame parallax data T2 as the frame parallax data after correction T3. For example, the frame parallax data after correction T3(tj) at the hour tj in FIG. 14 is calculated as an average of frame parallax data T2(t1), T2(tj), and T2(t2) at hours t1, tj, and t2 shown in FIG. 13. In other words, T3(tj)=(T2(t1)+T(tj)+T(t2))/3.

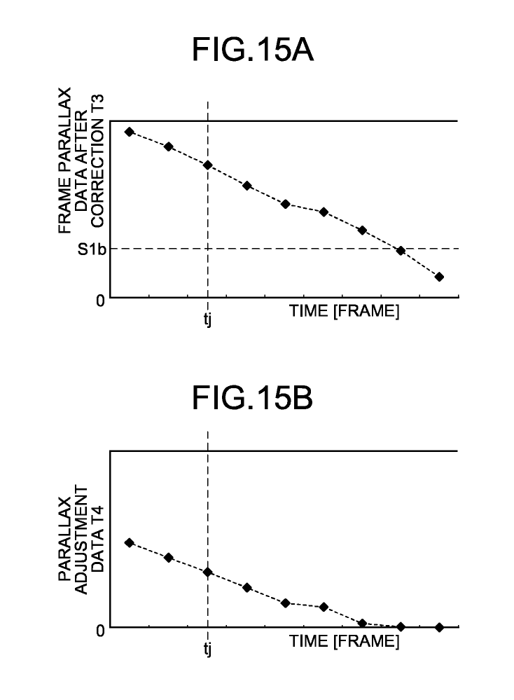

FIGS. 15A and 15B are diagrams for explaining a method of calculating the parallax adjustment data T4 from the frame parallax data after correction T3. FIG. 15A is a diagram of a temporal change of the frame parallax data after correction T3. The abscissa indicates time and the ordinate indicates the frame parallax data after correction T3. S1b indicates a parallax adjustment threshold. FIG. 15B is a diagram of a temporal change of the parallax adjustment data T4. The abscissa indicates time and the ordinate indicates the parallax adjustment data T4.

The image shown in FIG. 9 is a frame at the hour tj. The parallax-adjustment-amount calculating unit 4 outputs the parallax adjustment data T4 shown in FIG. 15B with respect to the frame parallax data after correction T3 shown in FIG. 15A. At an hour when the frame parallax data after correction T3 is equal to or smaller than the parallax adjustment threshold S1b and the image is not projected much, zero is output as the parallax adjustment data T4. Conversely, at a hour when the frame parallax data after correction T3 is larger than the parallax adjustment threshold S1b, a value obtained by multiplying an excess amount of the frame parallax data after correction T3 over the parallax adjustment threshold S1b with the parallax adjustment coefficient S1a is output as the parallax adjustment data T4.

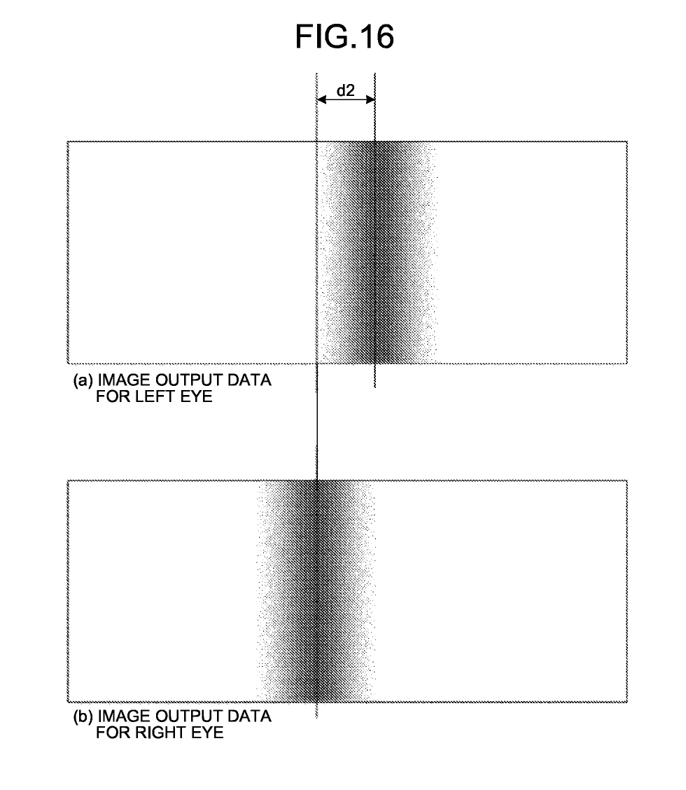

FIG. 16 is a diagram for explaining a method of calculating the image output data for left eye Da2 and the image output data for right eye Db2 from the parallax adjustment data T4, the image input data for left eye Da1, and the image input data for right eye Db1. An image shown in FIG. 16 is a frame at the hour tj same as the image shown in FIG. 9. FIG. 16(a) is a diagram of the image output data for left eye Da2. FIG. 16(b) is a diagram of the image output data for right eye Db2.

The adjusted-image generating unit 5 horizontally shifts, based on the parallax adjustment data T4 at the time tj shown in FIG. 15B, the image input data for left eye Da1 in the left direction by T4/2, which is a half value of the parallax adjustment data T4. The adjusted-image generating unit 5 horizontally shifts the image input data for right eye Db1 in the right direction by T4/2, which a half value of the parallax adjustment data T4. The adjusted-image generating unit 5 outputs the respective image data after the horizontal shift as the image output data for left eye Da2 and the image output data for right eye Db2. The parallax amount d2 shown in FIG. 16 is d1−T4 and is reduced compared with the parallax amount d1.

As explained above, in the three-dimensional video displayed in the image display apparatus 200 according to this embodiment, a projection amount can be controlled by reducing a parallax amount of a section having a large projection amount exceeding a threshold. Consequently, the image display apparatus 200 converts the image input data Da1 and Db1 into the image output data Da2 and Db2 having a parallax amount corresponding to the distance from the display surface 61 to the viewer 9, the individual difference of the viewer 9, and the like. In other words, the image display apparatus 200 can display the three-dimensional image with the parallax amount converted into a parallax amount for a suitable sense of depth.

In the first embodiment, the frame-parallax correcting unit 3 averages a plurality of the frame parallax data T2 before and after the frame of attention. The frame-parallax correcting unit 3 outputs an average of the frame parallax data T2 as the frame parallax data after correction T3. However, the frame-parallax correcting unit 3 can calculate a median of a plurality of the frame parallax data T2 before and after the frame of attention and output the median as the frame parallax data after correction T3. The frame-parallax correcting unit 3 can calculate, using other methods, a value obtained by correcting a plurality of the frame parallax data T2 before and after the frame of attention and output the frame parallax data after correction T3.

### Second Embodiment

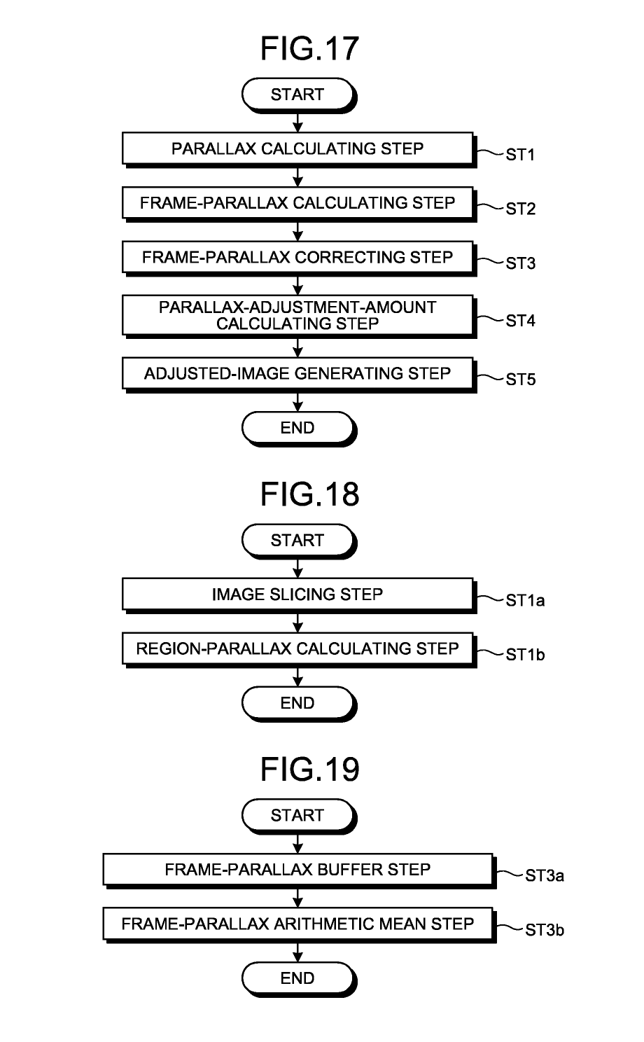

FIG. 17 is a flowchart for explaining a flow of an image processing method for a three-dimensional image according to a second embodiment of the present invention. The three-dimensional image processing method according to the second embodiment includes a parallax calculating step ST1, a frame-parallax calculating step ST2, a frame-parallax correcting step ST3, a parallax-adjustment-amount calculating step ST4, and an adjusted-image generating step ST5.

The parallax calculating step ST1 includes an image slicing step ST1a and a region-parallax calculating step ST1b as shown in FIG. 18.

The frame-parallax correcting step ST3 includes a frame-parallax buffer step ST3a and a frame-parallax arithmetic mean step ST3b as shown in FIG. 19.

The operation in the second embodiment of the present invention is explained below.

First, at the parallax calculating step ST1, processing explained below is applied to the image input data for left eye Da1 and the image input data for right eye Db1.

At the image slicing step ST1a, the image input data for left eye Da1 is sectioned in a lattice shape having width W1 and height H1 and divided into h×w regions on the display surface 61. At the image slicing step ST1a, the divided image input data for left eye Da1(1), Da1(2), and Da1(3) to Da1(h×w) are created. Similarly, the image input data for right eye Db1 is sectioned in a lattice shape having width W1 and height H1 to create the divided image input data for right eye Db1(1), Db1(2), and Db1(3) to Db1(h×w).

At the region-parallax calculating step ST1b, the parallax data T1(1) of the first region is calculated with respect to the image input data for left eye Da1(1) and the image input data for right eye Db1(1) for the first region using the phase limiting correlation method. Specifically, n at which the phase limiting correlation G_{ab}(n) is the maximum is calculated with respect to the image input data for left eye Da1(1) and the image input data for right eye Db1(1) and is set as the parallax data T1(1). The parallax data T1(2) to T1(h×w) are calculated with respect to the image input data for left eyes Da1(2) to Da1(h×w) for the second to h×w-th regions using the phase limiting correlation method. The parallax data T1(2) to T1(h×w) are also calculated with respect to the image input data for right eye Db1(2) to Db1(h×w) using the phase limiting correlation method. This operation is equivalent to the operation by the parallax calculating unit 1 in the first embodiment.

At the frame-parallax calculating step ST2, maximum parallax data among the parallax data T1(1) to T1(h×w) is selected and set as the frame parallax data T2. This operation is equivalent to the operation by the frame-parallax calculating unit 2 in the first embodiment.

At the frame-parallax correcting step ST3, processing explained below is applied to the frame parallax data T2.

At the frame-parallax buffer step ST3a, the temporally changing frame parallax data T2 is sequentially stored in a buffer storage device having a fixed capacity.

At the frame-parallax arithmetic mean step ST3b, an arithmetic mean of a plurality of the frame parallax data T2 before and after a frame of attention is calculated based on the frame parallax data T2 stored in the buffer region and the frame parallax data after correction T3 is calculated. This operation is equivalent to the operation by the frame-parallax correcting unit 3 in the first embodiment.

At the frame-parallax-adjustment-amount calculating step ST4, based on the set parallax adjustment coefficient S1a and parallax adjustment threshold S1b, the parallax adjustment data T4 is calculated from the frame parallax data after correction T3. At an hour when the frame parallax data after correction T3 is equal to or smaller than the parallax adjustment threshold S1b, the parallax adjustment data T4 is set to 0 (T4=0). Conversely, at an hour when the frame parallax data after correction T3 exceeds the parallax adjustment threshold S1b, a value obtained by multiplying an excess amount of the frame parallax data after correction T3 over the parallax adjustment threshold S1b with the parallax adjustment coefficient S1a is set as the parallax adjustment data T4 (T4=S1a×(T3−S1b)). This operation is equivalent to the operation by the parallax-adjustment-amount calculating unit 4 in the first embodiment.

At the adjusted-image generating step ST5, based on the parallax adjustment data T4, the image output data for left eye Da2 and the image output data for right eye Db2 are calculated from the image input data for left eye Da1 and the image input data for right eye Db1. Specifically, the image input data for left eye Da1 is horizontally shifted in the left direction by T4/2, which is a half value of the parallax adjustment data T4, and the image input data for right eye Db1 is horizontally shifted in the right direction by T4/2, which is a half value of the parallax adjustment data T4. Consequently, the image output data for left eye Da2 and the image output data for right eye Db2 with the parallax amount reduced by the parallax adjustment data T4 are generated. This operation is equivalent to the operation by the adjusted-image generating unit 5 in the first embodiment.

The operation of the image processing method for a three-dimensional image according to the second embodiment is as explained above.

According to the above explanation, the image processing method according to the second embodiment of the present invention is equivalent to the image processing apparatus 100 according to the first embodiment of the present invention. Therefore, the image processing method according to the second embodiment has effects same as those of the image processing apparatus 100 according to the first embodiment.

### Third Embodiment

In the first and second embodiments, a projection amount is controlled by reducing a parallax amount of an image having a large projection amount of a three-dimensional image. Consequently, the three-dimensional image is displayed with the parallax amount changed to a parallax amount for a suitable sense of depth corresponding to the distance from the display surface 61 to the viewer 9 and the individual difference of the viewer 9. In a third embodiment, a three-dimensional image is displayed with a parallax amount changed such that both a projection amount and a retraction amount of the three-dimensional image are in a suitable position corresponding to the distance from the display surface 61 to the viewer 9 and the individual difference of the viewer 9. However, the width of a depth amount from a projected position to a retracted position is not changed.

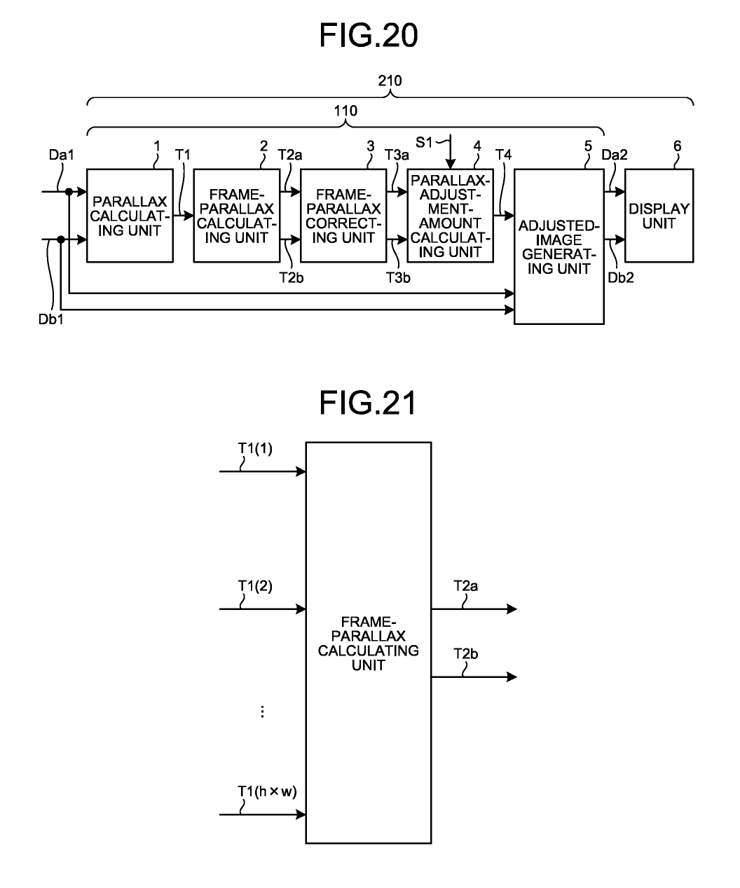

FIG. 20 is a diagram of the configuration of an image display apparatus 210 that displays a three-dimensional image according to the third embodiment of the present invention. The three-dimensional image display apparatus 210 according to the third embodiment includes the parallax calculating unit 1, the frame-parallax calculating unit 2, the frame-parallax correcting unit 3, the parallax-adjustment-amount calculating unit 4, the adjusted-image generating unit 5, and the display unit 6. An image processing apparatus 110 in the image display apparatus 210 includes the parallax calculating unit 1, the frame-parallax calculating unit 2, the frame-parallax correcting unit 3, the parallax-adjustment-amount calculating unit 4, and the adjusted-image generating unit 5.

The image input data for left eye Da1 and the image input data for right eye Db1 are input to the parallax calculating unit 1 and the adjusted-image generating unit 5. The parallax calculating unit 1 calculates, based on the image input data for left eye Da1 and the image input data for right eye Db1, a parallax amount in each of regions and outputs the parallax data T1. The parallax data T1 is input to the frame-parallax calculating unit 2.

The frame-parallax calculating unit 2 calculates, based on the parallax data T1, a parallax with respect to a frame of attention and outputs the parallax as first frame parallax data T2a and second frame parallax data T2b. The first frame parallax data T2a and the second frame parallax data T2b are input to the frame-parallax correcting unit 3.

The frame-parallax correcting unit 3 outputs first frame parallax data after correction T3a obtained by correcting the first frame parallax data T2a of the frame of attention referring to the first frame parallax data T2a of frames at other hours. The frame-parallax correcting unit 3 outputs second frame parallax data after correction T3b obtained by correcting the second frame parallax data T2b of the frame of attention referring to the second frame parallax data T2b of frames at other hours. The first frame parallax data after correction T3a and the second frame parallax data after correction T3b are input to the parallax-adjustment-amount calculating unit 4.

The parallax-adjustment-amount calculating unit 4 outputs the parallax adjustment data T4 calculated based on the parallax adjustment information S1 input by the viewer 9, the first frame parallax data after correction T3a, and the second frame parallax data after correction T3b. The parallax adjustment data T4 is input to the adjusted-image generating unit 5.

The adjusted-image generating unit 5 outputs the image output data for left eye Da2 and the image output data for right eye Db2 obtained by adjusting, based on the parallax adjustment data T4, a parallax amount between the image input data for left eye Da1 and the image input data for right eye Db1. The image output data for left eye Da2 and the image output data for right eye Db2 are input to the display unit 6. The display unit 6 displays the image output data for left eye Da2 and the image output data for right eye Db2 on the display surface.

The detailed operations of the image processing apparatus 110 according to the third embodiment of the present invention are explained below.

Because explanation of the parallax calculating unit 1 and the region-parallax calculating unit 1b is the same as the explanation made with reference to FIGS. 2, 3, and 4(a) to 4(c) in the first embodiment, the explanation is omitted. Because explanation of the phase limiting correlation method is the same as the explanation made with reference to Formulas (1) to (4) in the first embodiment, the explanation is omitted.

Therefore, the detailed operations of the frame-parallax calculating unit 2 are explained below.

FIG. 21 is a diagram for explaining in detail the parallax data T1 input to the frame-parallax calculating unit 2. The frame-parallax calculating unit 2 aggregates the input parallax data T1(1) to T1(h×w) corresponding to the first to h×w-th regions and calculates one first frame parallax data T2a and one second frame parallax data T2b with respect to an image of the frame of attention.

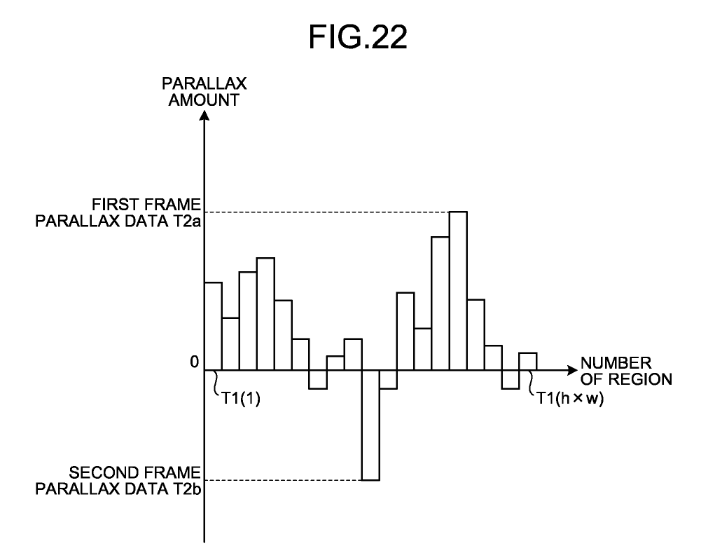

FIG. 22 is a diagram for explaining a method of calculating, based on the parallax data T1(1) to T(h×w), the first frame parallax data T2a and the second frame parallax data T2b. The abscissa indicates a number of a region and the ordinate indicates the parallax data T1 (a parallax amount). The frame-parallax calculating unit 2 outputs maximum parallax data T1 among the parallax data T1(1) to T(h×w) as the first frame parallax data T2a of a frame image and outputs minimum parallax data T1 as the second frame parallax data T2b.

Consequently, concerning a three-dimensional video not embedded with parallax information, it is possible to calculate a parallax amount in a section projected most and a section retracted most in frames of the three-dimensional video considered to have the largest influence on the viewer 9.

The detailed operations of the frame-parallax correcting unit 3 are explained below.

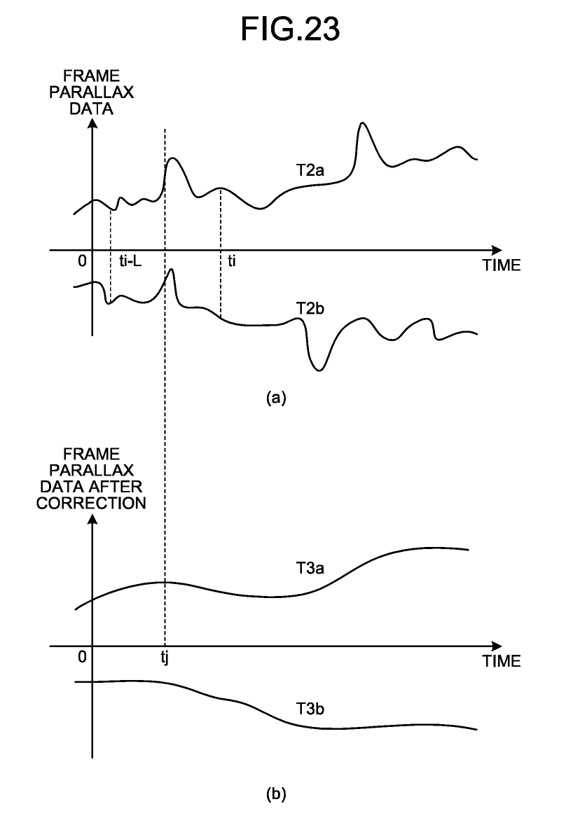

FIG. 23 is a diagram for explaining in detail first frame parallax data after correction T3a and second frame parallax data after correction T3b calculated from the first frame parallax data T2a and the second frame parallax data T2b. FIG. 23(a) is a diagram of a temporal change of the first frame parallax data T2a and the second frame parallax data T2b. The abscissa indicates time and the ordinate indicates the magnitude of the frame parallax data T2a and T2b. FIG. 23(b) is a diagram of a temporal change of the first frame parallax data after correction T3a and the second frame parallax data after correction T3b. The abscissa indicates time and the ordinate indicates the frame parallax data after correction T3a and T3b.

The frame-parallax correcting unit 3 stores the first frame parallax data T2a for a fixed time, calculates an average of a plurality of the first frame parallax data T2a before and after the frame of attention, and outputs the average as the first frame parallax data after correction T3a. The frame-parallax correcting unit 3 stores the second frame parallax data T2b for a fixed time, calculates an average of a plurality of the second frame parallax data T2b before and after the frame of attention, and outputs the average as the second frame parallax data after correction T3b. T3a is represented by the following Formula (7a) and T3b is represented by the following Formula (7b):

$$\begin{matrix}T 3 a ( tj ) = \frac{{\sum }_{k = ti - L}^{ti} T 2 a ( k )}{L} & ( 7 a ) \\ T 3 b ( tj ) = \frac{{\sum }_{k = ti - L}^{ti} T 2 b ( k )}{L} & ( 7 b )\end{matrix}$$

where, T3a(tj) represents first frame parallax data after correction at the hour tj of attention and T3b(tj) represents second frame parallax data after correction at the time tj of attention. T2a(k) represents first frame parallax data at the hour k and T2b(k) represents second frame parallax data at the hour k. A positive integer L represents width for calculating an average. Because ti<tj, for example, the first frame parallax data after correction T3a at the hour tj shown in FIG. 23(b) is calculated from an average of the first frame parallax data T2a from the hour (ti−L) to the hour ti shown in FIG. 23(a). The second frame parallax data after correction T3b at the hour tj shown in FIG. 23(b) is calculated from an average of the second frame parallax data T2b from the hour (ti−L) to the hour ti.

Most projection amounts of a three-dimensional video temporally continuously change. When the first frame parallax data T2a and the second frame parallax data T2b temporally discontinuously change, for example, when the first frame parallax data T2a and the second frame parallax data T2b change in an impulse shape with respect to a time axis, it can be regarded that misdetection of the first frame parallax data T2a and the second frame parallax data T2b occurs. Because the frame-parallax data correcting unit 3 temporally averages the first frame parallax data T2a and the second frame parallax data T2b even if there is the change in the impulse shape, the misdetection can be eased.

The detailed operations of the parallax-adjustment-amount calculating unit 4 are explained below.

The parallax-adjustment-amount calculating unit 4 calculates, based on the parallax adjustment information S1 set by the viewer 9 according to a parallax amount, with which the viewer 9 can easily see an image, the first frame parallax data after correction T3a, and the second frame parallax data after correction T3b, a parallax adjustment amount and outputs the parallax adjustment data T4.

The parallax adjustment information S1 includes a parallax adjustment coefficient S1a, a first parallax adjustment threshold S1b, and a second parallax adjustment threshold S1c. First, the parallax-adjustment-amount calculating unit 4 calculates, based on the parallax adjustment coefficient S1a, the first parallax adjustment threshold S1b, and the first frame parallax data after correction T3a, intermediate parallax adjustment data V (not-shown) according to a formula represented by the following Formula (8):

$$V = \{ \begin{matrix}0 & ( T 3 a \leq S 1 b ) \\ S 1 a \times ( T 3 a - S 1 b ) & ( T 3 a > S 1 b )\end{matrix} \qquad ( 8 )$$

When the first frame parallax data after correction T3a is equal to or smaller than the first parallax adjustment threshold S1b, the intermediate parallax adjustment data V is set to 0. On the other hand, when the first frame parallax data after correction T3a is larger than the first parallax adjustment threshold S1b, a value obtained by multiplying a value of a difference between the first frame parallax data after correction T3a and the first parallax adjustment threshold S1b with the parallax adjustment coefficient S1a is set as the intermediate parallax adjustment data V.

The parallax-adjustment-amount calculating unit 4 calculates, based on the second parallax adjustment threshold S1c, the second frame parallax data after correction T3b, and the intermediate parallax adjustment data V, the parallax adjustment data T4 according to a formula represented by the following Formula (9):

$$T 4 = \{ \begin{matrix}0 & \{ ( T 3 b \leq S 1 c ) \} \\ V - ( T 3 b - S 1 c ) & ( T 3 b > S 1 c ) ⋂ \{ V \geq ( T 3 b - S 1 c ) \} \\ V & ( T 3 b > S 1 c ) ⋂ \{ V < ( T 3 b - S 1 c ) \}\end{matrix} \qquad ( 9 )$$

The parallax adjustment data T4 means a parallax amount for reducing a projection amount according to image adjustment. The parallax adjustment data T4 indicates amounts for horizontally shifting the image input data for left eye Da1 and the image input data for right eye Db1. As explained in detail later, a sum of the amounts for horizontally shifting the image input data for left eye Da1 and the image input data for right eye Db1 is the parallax adjustment data T4.

When the second frame parallax data after correction T3b is equal to or smaller than the second parallax adjustment threshold S1c, the parallax-adjustment-amount calculating unit 4 does not shift the image input data for left eye Da1 and the image input data for right eye Db1 in the horizontal direction according to the image adjustment. On the other hand, when the second frame parallax data after correction T3 is larger than the second parallax adjustment threshold S1c and the intermediate parallax adjustment data V is equal to or larger than a value obtained by subtracting the second parallax adjustment threshold S1c from the second frame parallax data after correction T3b, the parallax-adjustment-amount calculating unit 4 shifts the image input data for left eye Da1 and the image input data for right eye Db1 in the horizontal direction by a value obtained by subtracting, from the intermediate parallax adjustment data V, the value obtained by subtracting the second parallax adjustment threshold S1c from the second frame parallax data after correction T3b. When the second frame parallax data after correction T3b is larger than the second parallax adjustment threshold S1c and the intermediate parallax adjustment data V is smaller than the value obtained by subtracting the second parallax adjustment threshold S1c from the second frame parallax data after correction T3b, the parallax-adjustment-amount calculating unit 4 shifts the image input data for left eye Da1 and the image input data for right eye Db1 in the horizontal direction by a value of the intermediate parallax adjustment data V.

In short, the parallax-adjustment-amount calculating unit 4 calculates, based on the intermediate parallax adjustment data V, the parallax adjustment data T4 according to a relation between the second frame parallax data after correction T3b and the second parallax adjustment threshold S1c.

For example, in the case of the parallax adjustment coefficient S1a=1, the first parallax adjustment threshold S1b=0, and the second parallax adjustment threshold S1c=−4, T4=0 when T3a≦0 according to Formula (8). In other words, image adjustment is not performed. On the other hand, V=T3a when T3a>0. According to Formula (9), when T3b−V has a value larger than −4, T4=V(=T3a), and the image input data for left eye Da1 and the image input data for right eye Db1 are shifted in the horizontal direction by T3a. In other words, as a result of being adjusted based on a maximum parallax of a frame image, when a minimum parallax amount of the frame image is not smaller than the second parallax adjustment threshold S1c, adjustment is performed for the amount of the intermediate parallax adjustment data V. The first frame parallax data after correction T3a is maximum parallax data of the frame image. Therefore, the parallax adjustment data T4 is calculated such that a maximum parallax amount in the frame of attention is zero.

Conversely, when T3a>0 and T3b−V has a value smaller than −4, T4=T3a−(T3b−(−4)). The image input data for left eye Da1 and the image input data for right eye Db1 are shifted in the horizontal direction by T3a−(T3b−(−4)). In other words, as a result of being adjusted based on the maximum parallax of the frame image, when the minimum parallax amount of the frame image is smaller than the second parallax adjustment threshold S1c, adjustment is performed by a value obtained by subtracting, from the intermediate parallax adjustment data V, the value obtained by subtracting the second parallax adjustment threshold S1c from the second frame parallax data after correction T3b. By limiting an adjustment amount in this way, the minimum parallax amount of the frame image is prevented from being smaller than the second parallax adjustment threshold S1c.

As explained above, the parallax-adjustment-amount calculating unit 4 outputs, as the parallax adjustment data T4, a result obtained by controlling the value of the intermediate parallax adjustment data V to be small according to a relation between the minimum parallax amount of the frame image and the second parallax adjustment threshold S1c. Consequently, it is possible to suppress the minimum parallax amount of the frame image from being set excessively small. The minimum parallax amount of the frame image is the second frame parallax data after correction T3b.

For example, a user determines the setting of the parallax adjustment information S1 while changing the parallax adjustment information S1 with input means such as a remote controller and checking a change in a projection amount of a three-dimensional image. The user can also input the parallax adjustment information S1 from a parallax adjustment coefficient button and a parallax adjustment threshold button of the remote controller. However, the predetermined parallax adjustment coefficient S1a and the parallax adjustment threshold S1b can be set when the user inputs an adjustment degree of a parallax from one ranked parallax adjustment button.

The image display apparatus 210 can include a camera or the like for observing the viewer 9, discriminate the age of the viewer 9, the sex of the viewer 9, the distance from the display surface to the viewer 9, and the like, and automatically set the parallax adjustment information S1. In this case, the size of a display surface of the image display apparatus 210 and the like can be included in the parallax adjustment information S1. Only predetermined values of the size of the display surface of the image display apparatus 210 and the like can also be set as the parallax adjustment information S1. As explained above, information including personal information, the age of the viewer 9, and the sex of the viewer 9 input by the viewer 9 using the input means such as the remote controller, positional relation including the distance between the viewer 9 and the image display apparatus, and information related to a situation of viewing such as the size of the display surface of the image display apparatus is referred to as information indicating a situation of viewing.

The operation of the adjusted-image generating unit 5 is explained below.

The operation of the adjusted-image generating unit 5 is explained with reference to FIG. 8 in the first embodiment. The relation among the parallax amount between the image input data for left eye Da1 and the image input data for right eye Db1, the parallax amount between the image output data for left eye Da2 and the image output data for right eye Db2, and the projection amount explained in the first embodiment is the same as the details explained the first embodiment. Therefore, explanation of the relation is omitted.

The first frame parallax data after correction T3a is calculated from the first frame parallax data T2a, which is the maximum parallax data of the frame image. The second frame parallax data after correction T3b is calculated from the second frame parallax data T2b, which is the minimum parallax data of the frame image. Therefore, the first frame parallax data after correction T3a is the maximum parallax data of the frame image and the second frame parallax data after correction T3b is the minimum parallax data of the frame image. The intermediate parallax adjustment data V is calculated based on the first frame parallax data after correction T3a according to Formula (8). Therefore, when the parallax adjustment coefficient S1a is 1, the intermediate parallax adjustment data V is equal to a maximum parallax amount in the frame of attention. When the parallax adjustment coefficient S1a is smaller than 1, the intermediate parallax adjustment data V is smaller than the maximum parallax amount. If it is assumed that the parallax amount d1 shown in FIG. 8(a) is the maximum parallax amount calculated in the frame of attention, when the parallax adjustment coefficient S1a is set smaller than 1, the maximum parallax amount d2 after adjustment shown in FIG. 8(b) is a value smaller than the parallax amount d1. When the parallax adjustment coefficient S1a is set to 1, the parallax adjustment threshold S1b is set to 0, and a value obtained by subtracting the intermediate parallax adjustment data V from the first frame parallax data after correction T3a is larger than the parallax adjustment threshold S1c, a video is an image that is not projected and the parallax amount d2 is 0. Consequently, the maximum projected position F2 of the image data after adjustment is adjusted to a position between the display surface 61 and the projected position F1.

Because the operation of the display unit 6 is the same as that in the first embodiment, explanation of the operation is omitted.

Consequently, the image processing apparatus 110 according to this embodiment can display a three-dimensional image with a parallax between an input pair of images changed to a parallax amount for a sense of depth suitable for the viewer 9 corresponding to the distance from the display surface 61 to the viewer 9, the individual difference of the viewer 9, and the like.

The detailed operations of the image display apparatus 210 that displays a three-dimensional image according to the third embodiment of the present invention are explained above.

The third embodiment is explained below based on a specific image example.

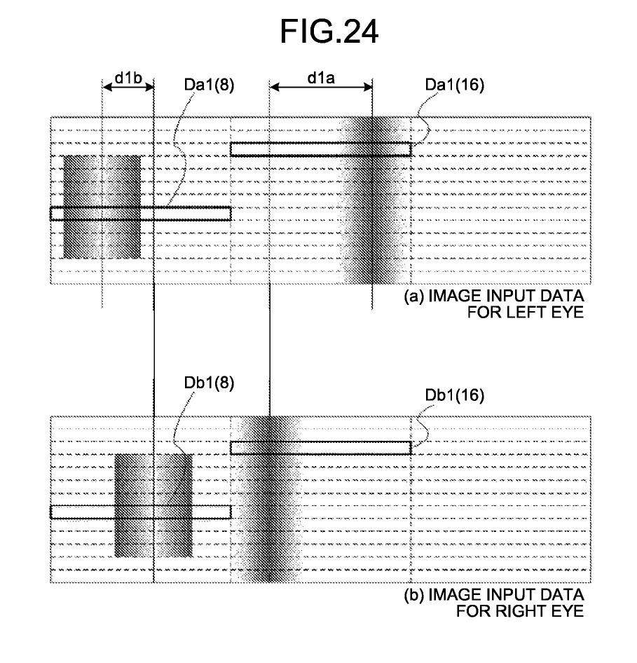

FIG. 24 is a diagram of a specific example of the image input data for left eye Da1 and the image input data for right eye Db1. FIG. 24(a) is a diagram of the entire image input data for left eye Da1. FIG. 24(b) is a diagram of the entire image input data for right eye Db1. Between the image input data for left eye Da1 and the image input data for right eye Db1, there is a parallax of a parallax amount d1a in the horizontal direction in a region in the center and a parallax of a parallax amount d1b in the horizontal direction in a region on the left side. In the image input data for left eye Da1 and the image input data for right eye Db1, boundaries for sectioning the image input data for left eye Da1 and the image input data for right eye Db1 into regions for calculating a parallax amount are indicated by broken lines. Each of the image input data for left eye Da1 and the image input data for right eye Db1 is divided into, in order from a region at the most upper left, a first region, a second region, and a third region to a thirty-ninth region at the most lower right. Image input data for left eye Da1(8) and image input data for right eye Db1(8) in an eighth region are indicated by thick solid lines. Image input data for left eye Da1(16) and the image input data for right eye Db1(16) in a sixteenth region are indicated by thick solid lines.

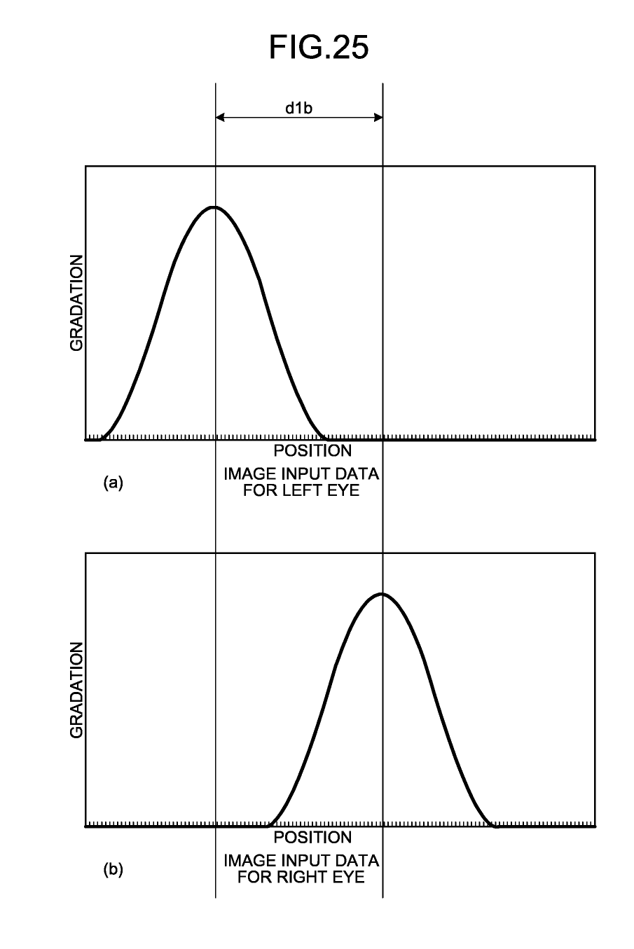

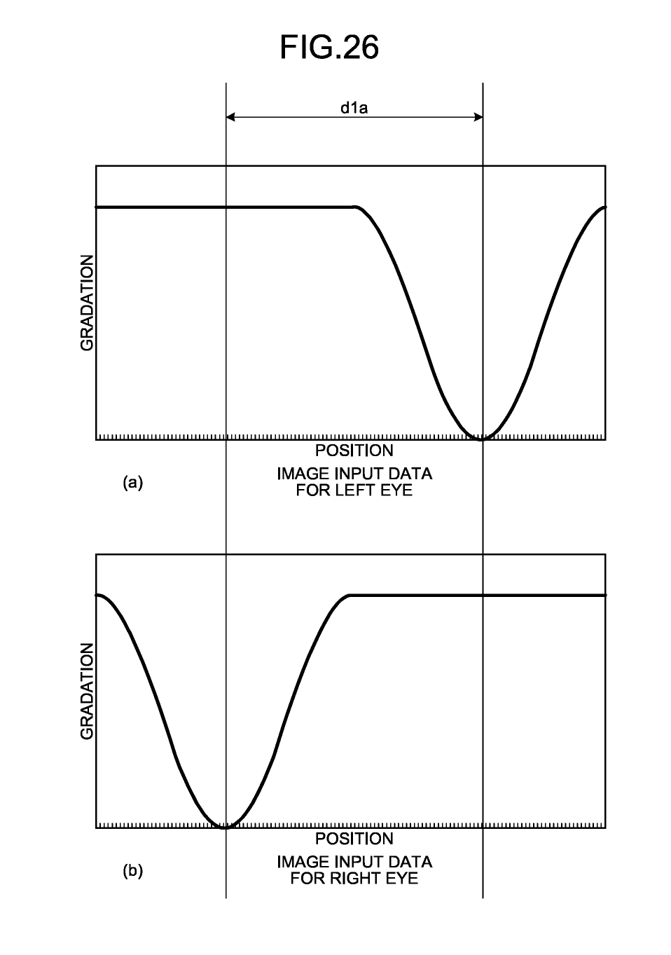

FIG. 25 is a diagram for explaining a method of calculating a parallax amount from the image input data for left eye Da1(8) and the image input data for right eye Db1(8). FIG. 26(a) is a diagram of a relation between a horizontal position and a gradation of the image input data for left eye Da1(8). FIG. 26(b) is a diagram of a relation between a horizontal position and a gradation of the image input data for right eye Db1(8). The abscissa indicates the horizontal position and the ordinate indicates the gradation.

Both the image input data for left eye Da1(8) and the image input data for right eye Db1(8) are represented as graphs including regions that change in a convex trough shape in a direction in which the gradation increases. Positions of maximum values of the image input data for left eye Da1(8) and the image input data for right eye Db1(8) shift exactly by the parallax amount d1b. The image input data for left eye Da1(8) and the image input data for right eye Db1(8) are input to a region-parallax calculating unit 1b(8) of the parallax calculating unit 1. The parallax amount d1b is output as parallax data T1(8) of the eighth region.

FIG. 26 is a diagram for explaining a method of calculating a parallax amount from the image input data for left eye Da1(16) and the image input data for right eye Db1(16). FIG. 25(a) is a diagram of a relation between a horizontal position and a gradation of the image input data for left eye Da1(16). FIG. 25(b) is a diagram of a relation between a horizontal position and a gradation of the image input data for right eye Db1(16). The abscissa indicates the horizontal position and the ordinate indicates the gradation.

Both the image input data for left eye Da1(16) and the image input data for right eye Db1(16) are represented as curves including regions that change in a convex trough shape in a direction in which the gradation decreases. Positions of minimum values of the image input data for left eye Da1(16) and the image input data for right eye Db1(16) shift exactly by the parallax amount d1a. The image input data for left eye Da1(16) and the image input data for right eye Db1(16) are input to a region-parallax calculating unit 1b(16) of the parallax calculating unit 1. The parallax amount d1a is output as parallax data T1(16) of the sixteenth region.

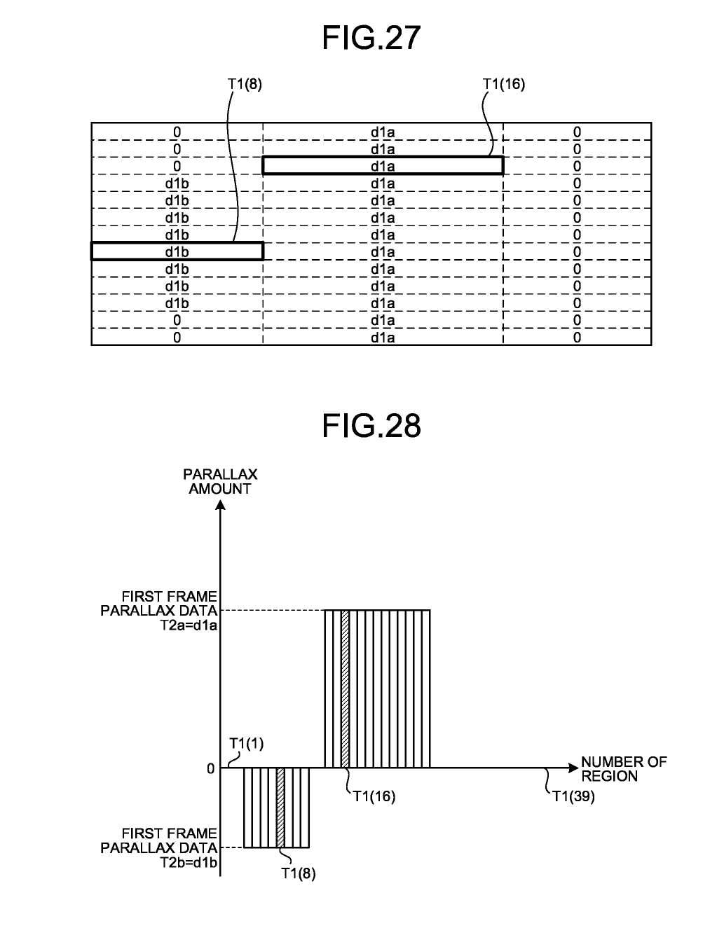

FIG. 27 is a diagram of the parallax data T1 output by the parallax calculating unit 1. Values of the parallax data T1(1) to the parallax data T1(39) output by the region-parallax calculating unit 1b(1) to the region-parallax calculating unit 1b(39) are shown in regions sectioned by broken lines.

FIG. 28 is a diagram for explaining calculation of the first frame parallax data T2a and the second frame parallax data T2b from the parallax data T1. The abscissa indicates numbers of regions and the ordinate indicates a parallax amount (the parallax data T1).

In FIG. 28, for example, the parallax data T1(8) in the eight region and the parallax data T1(16) in the sixteenth region are indicated by hatching. The frame-parallax calculating unit 2 compares the parallax data T1 input from the parallax calculating unit 1, outputs the parallax amount d1a, which is the maximum, as the first frame parallax data T2a, and outputs the parallax amount d1b, which is the minimum, as the second frame parallax data T2b.

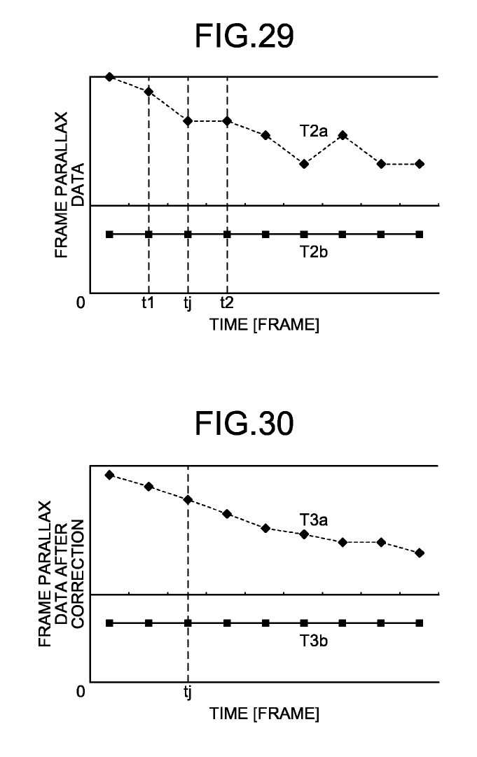

FIG. 29 is a diagram of temporal changes of the first frame parallax data T2a and the second frame parallax data T2b output by the frame-parallax calculating unit 2. In FIG. 29, data in the position of the hour tj corresponds to the frame at the hour tj of the image shown in FIG. 24.

FIG. 30 is a diagram for explaining a method of calculating the first frame parallax data after correction T3a from the first frame parallax data T2a and a method of calculating the second frame parallax data after correction T3b from the second frame parallax data T2b. In FIG. 30, temporal changes of the first frame parallax data after correction T3a and the second frame parallax data after correction T3b are shown. The abscissa indicates time and the ordinate indicates the sizes of the frame parallax data after correction T3a and T3b. The frame-parallax correcting unit 3 outputs, with the width L for calculating an average set to 3, an average of the first frame parallax data T2a of the frame of attention and the frames before and after the frame of attention as the first frame parallax data after correction T3a using Formula (7). The frame-parallax correcting unit 3 outputs, with the width L for calculating an average set to 3, an average of the second frame parallax data T2b of the frame of attention and the frames before and after the frame of attention as the second frame parallax data after correction T3b using Formula (7). For example, the first frame parallax data after correction T3a(tj) at the hour tj in FIG. 30 is calculated as an average of first frame parallax data T2a(t1), T2a(tj), and T2a(t2) at the hours t1, tj, and t2 shown in FIG. 29. In other words, T3a(tj)=(T2a(t1)+T2a(tj)+T2a(t2))/3.

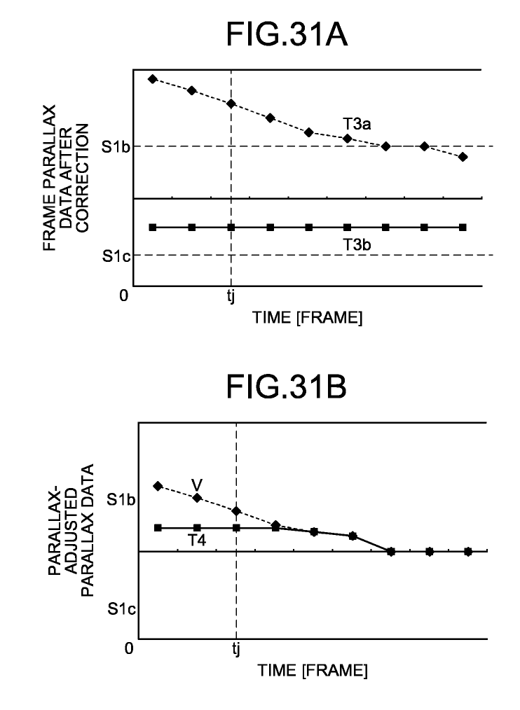

FIGS. 31A and 31B are diagrams for explaining a method of calculating, based on Formula (9), the intermediate parallax adjustment data V and the parallax adjustment data T4 from the first frame parallax data after correction T3a and the second frame parallax data after correction T3b in the parallax-adjustment-amount calculating unit 4. FIG. 31A is a diagram of temporal changes of the first frame parallax data after correction T3a and the second frame parallax data after correction T3b. S1b represents a first parallax adjustment threshold and S1c represents a second parallax adjustment threshold. The abscissa indicates time and the ordinate indicates the size of the frame parallax data after correction T3. FIG. 31B is a diagram of temporal changes of the intermediate parallax adjustment data V and the parallax adjustment data T4. The abscissa indicates time and the ordinate indicates the sizes of the parallax adjustment data V and T4.

The parallax-adjustment-amount calculating unit 4 outputs, based on the first frame parallax data after correction T3a shown in FIG. 31A, the intermediate parallax adjustment data V shown in FIG. 31B. At an hour when the first frame parallax data after correction T3a is equal to or smaller than the first parallax adjustment threshold S1b, the intermediate parallax adjustment data V is output as zero. The hour when the first frame parallax data after correction T3a is equal to or smaller than the first parallax adjustment threshold S1b is an hour when an image is not projected much. Conversely, in a hour when the first frame parallax data after correction T3a is larger than the first parallax adjustment threshold S1b, a value obtained by multiplying an excess amount of the first frame parallax data after correction T3a over the first parallax adjustment threshold S1b with the parallax adjustment coefficient S1a is output as the intermediate parallax adjustment data V.

The parallax-adjustment-amount calculating unit 4 calculates, based on the second frame parallax data after correction T3b shown in FIG. 31A and the intermediate parallax adjustment data V, the parallax adjustment data T4 shown in FIG. 31B. At an hour when a value as a result of subtracting the intermediate parallax adjustment data V from the second frame parallax data after correction T3b is equal to or smaller than the second parallax adjustment threshold S1c (T3b−V≦S1c), the parallax adjustment data T4 is a value obtained by subtracting, from the intermediate parallax adjustment data V, a value obtained by subtracting the second parallax adjustment threshold S1c from the second frame parallax data after correction T3b (T4=V−(T3b−S1c)). The hour when the value as a result of subtracting the intermediate parallax adjustment data V from the second frame parallax data after correction T3b is equal to or smaller than the second parallax adjustment threshold S1c (T3b−VS1c) is an hour when a minimum parallax amount of a frame image is equal to or smaller than the second parallax adjustment threshold S1c as a result of performing adjustment using the intermediate parallax adjustment data V.

Conversely, at an hour when the value as a result of subtracting the intermediate parallax adjustment data from the second frame parallax data after correction T3b is larger than the second parallax adjustment threshold S1c (T3b−V>S1c), the parallax adjustment data T4 is equal to the intermediate parallax adjustment data V (T4=V). The hour when the value as a result of subtracting the intermediate parallax adjustment data V from the second frame parallax data after correction T3b is larger than the second parallax adjustment threshold S1c (T3b−V>S1c) is an hour when a minimum parallax amount of a frame image is not equal to or smaller than the second parallax adjustment threshold S1c as a result of performing adjustment using the intermediate parallax adjustment data V.

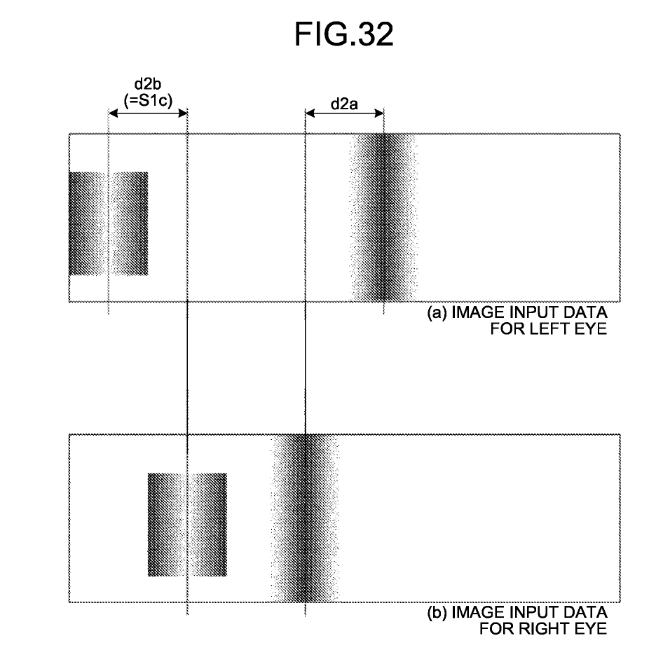

FIG. 32 is a diagram for explaining a method of calculating the image output data for left eye Da2 and the image output data for right eye Db2 from the image input data for left eye Da1 and the image input data for right eye Db1. An image shown in FIG. 32 is a frame at the hour tj same as the image shown in FIG. 24. FIG. 32(a) is a diagram of the image output data for left eye Da2. FIG. 32(b) is a diagram of the image output data for right eye Db2.

The adjusted-image generating unit 5 horizontally shifts, based on the parallax adjustment data 14 at the hour tj shown in FIG. 31B, the image input data for left eye Da1 to the left by T4/2, which is a half value of the parallax adjustment data T4, and outputs the image input data for left eye Da1 as the image output data for left eye Da2. The adjusted-image generating unit 5 horizontally shifts, based on the parallax adjustment data T4 at the hour tj shown in FIG. 31B, the image input data for right eye Db1 to the right by T4/2, which is a half value of the parallax adjustment data T4, and outputs the image input data for right eye Db1 as the image output data for right eye Db2. The parallax amount d2a shown in FIG. 32 is d1a−T4 and decreases compared with the parallax amount d1a. The parallax amount d2b shown in FIG. 32 is d1b−T4 and decreases compared with the parallax amount d1b. The parallax amount d2b in this case is equal to the parallax adjustment threshold S1c.

As explained above, in a three-dimensional video displayed in the image display apparatus 210 in this embodiment, a projection amount can be controlled by reducing a parallax amount of an image having a large projection amount exceeding a threshold. Consequently, the image display apparatus 210 can display a three-dimensional image with a parallax changed to a parallax amount for a suitable sense of depth corresponding to the distance from the display surface 61 to the viewer 9 and the individual difference of the viewer 9.

In the example explained in the third embodiment, the frame-parallax correcting unit 3 calculates averages of a plurality of the first frame parallax data T2a and second frame parallax data T2b before and after the frame of attention and outputs the averages respectively as the first frame parallax data after correction T3a and the second frame parallax data after correction T3b. However, the frame-parallax correcting unit 3 can calculate medians of a plurality of the first frame parallax data T2a and second frame parallax data T2b before and after the frame of attention and output the medians as the first frame parallax data after correction T3a and the second frame parallax data after correction T3b. The frame-parallax correcting unit 3 can calculate corrected values from a plurality of the first frame parallax data T2a and second frame parallax data T2b before and after the frame of attention and output the first frame parallax data after correction T3a and the second frame parallax data after correction T3b.

### Fourth Embodiment

An image processing method for the image processing apparatus 110 explained in the third embodiment is explained. As figures used for the explanation, FIGS. 17 and 19 in the second embodiment are used. Because explanation of the parallax calculating step ST1 is the same as that in the second embodiment including the explanation made with reference to FIG. 18, the explanation is omitted.

The explanation is started from the frame-parallax calculating step ST2. The frame-parallax correcting step ST3 includes the frame parallax buffer step ST3a and the frame-parallax arithmetic mean step ST3b as shown in FIG. 19.

At the frame-parallax calculating step ST2, maximum parallax data T1 among the parallax data T1(1) to T1(h×w) is selected and set as the first frame parallax data T2a. Minimum parallax data T1 among the parallax data T1(1) to T1(h×w) is selected and set as the second frame parallax data T2b. This operation is equivalent to the operation by the frame-parallax calculating unit 2 in the third embodiment.

At the frame-parallax correcting step ST3, processing explained below is applied to the first frame parallax data T2a and the second frame parallax data T2b.

At the frame-parallax buffer step ST3a, the temporally changing first frame parallax data T2a and second frame parallax data T2b are sequentially stored in a buffer storage device having a fixed capacity.

At the frame-parallax arithmetic mean step ST3b, an arithmetic mean of a plurality of the first frame parallax data T2a before and after the frame of attention stored in a buffer region is calculated and the first frame parallax data after correction T3a is calculated. An arithmetic mean of a plurality of the second frame parallax data T2b before and after the frame of attention stored in the buffer region is calculated and the second frame parallax data after correction T3b is calculated. This operation is equivalent to the operation by the frame-parallax correcting unit 3 in the third embodiment.

At the frame-parallax-adjustment-amount calculating step ST4, based on the set parallax adjustment coefficient S1a, first parallax adjustment threshold S1b, and second parallax adjustment threshold S1c, first, the intermediate parallax adjustment amount V is calculated from the first frame parallax data after correction T3a and the second parallax frame data after correction T3b. At an hour when the first frame parallax data after correction T3a is equal to or smaller than the first parallax adjustment threshold S1b, the intermediate parallax adjustment data V is set to 0. On the other hand, at an hour when the first frame parallax data after correction T3a is larger than the first parallax adjustment threshold S1b, a value obtained by multiplying a value of a difference between the first frame parallax data after correction T3a and the first parallax adjustment threshold S1b with the parallax adjustment coefficient S1a is set as the intermediate parallax adjustment data V (V=S1a×(T3a−S1b)).

The parallax adjustment data T4 is calculated based on the second parallax adjustment threshold S1c, the second frame parallax data after correction T3b, and the intermediate parallax adjustment data V. At an hour when the second frame parallax data after correction T3b is equal to or smaller than the second parallax adjustment threshold S1c, the parallax adjustment data T4 is set to 0. On the other hand, at an hour when the second frame parallax data after correction T3b is larger than a value of the second parallax adjustment threshold S1c (T3b>S1c) and the intermediate parallax adjustment data V is equal to or larger than a value obtained by subtracting the second parallax adjustment threshold S1c from the second frame parallax data after correction T3b (V≧T3b−S1c), the parallax adjustment data T4 is set to a value obtained by subtracting, from the intermediate parallax adjustment data V, the value obtained by subtracting the second parallax adjustment threshold S1c from the second frame parallax data after correction T3b (T4=V−(T3b−S1c)). At an hour when the second frame parallax data after correction T3b is larger than the value of the second parallax adjustment threshold Sc1 (T3b>S1c) and the intermediate parallax adjustment data V is smaller than the value obtained by subtracting the second parallax adjustment threshold S1c from the second frame parallax data after correction T3b (V<T3b−S1c), the parallax adjustment data T4 is equal to the value of the intermediate parallax adjustment data V (T4=V). This operation is the same as the operation by the parallax-adjustment-amount calculating unit 4 in the third embodiment.

At the adjusted-image generating step ST5, the image output data for left eye Da2 and the image output data for right eye Db2 are calculated based on the parallax adjustment data T4 from the image input data for left eye Da1 and the image input data for right eye Db1. Specifically, the image input data for left eye Da1 is horizontally shifted to the left by T4/2, which is a half value of the parallax adjustment data T4, and the image input data for right eye is horizontally shifted to the right by T4/2, which is a half value of the parallax adjustment data T4. Consequently, the image output data for left eye Da2 and the image output data for right eye Db2 with a parallax amount reduced by T4 are generated. This operation is the same as the operation by the adjusted-image generating unit 5 in the third embodiment.

In the image processing method configured as explained above, a three-dimensional image can be displayed with a parallax amount between an input pair of images changed to a parallax for a suitable sense of depth corresponding to the distance from the display surface 61 to the viewer 9 and the personal difference of the viewer 9.

### Fifth Embodiment

In the first embodiment, the processing by the parallax calculating unit 1 and the frame-parallax calculating unit 2 is performed using the input image data Da1 and Db1. In a fifth embodiment, processing by the parallax calculating unit 1 and the frame-parallax calculating unit 2 is performed with the input image data Da1 and Db1 reduced by an image reducing unit 7. Thereafter, frame parallax data is expanded by a frame-parallax expanding unit 8 before data is output to the frame-parallax correcting unit 3.

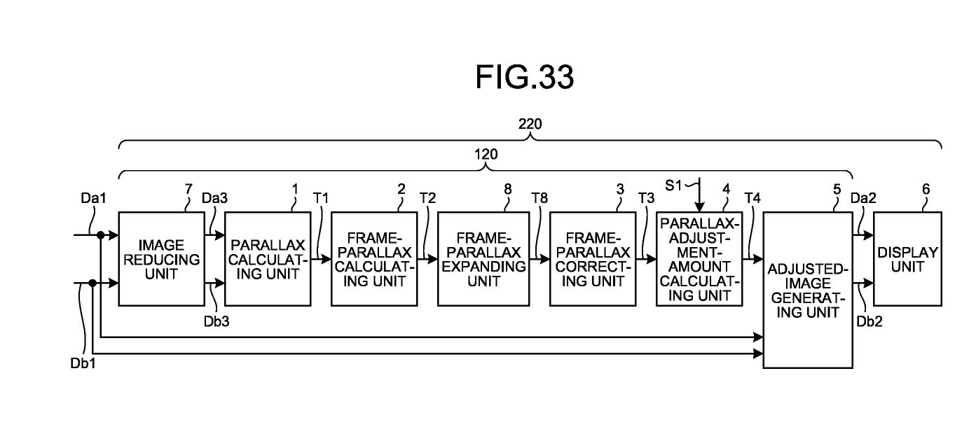

FIG. 33 is a schematic diagram of the configuration of an image display apparatus 220 that displays a three-dimensional image according to the fifth embodiment for carrying out the present invention. The three-dimensional image display apparatus 220 according to the fifth embodiment includes the image reducing unit 7, the parallax calculating unit 1, the frame-parallax calculating unit 2, the frame-parallax expanding unit 8, the frame-parallax correcting unit 3, the parallax-adjustment-amount calculating unit 4, the adjusted-image generating unit 5, and the display unit 6. An image processing apparatus 120 in the image display apparatus 220 includes the image reducing unit 7, the parallax calculating unit 1, the frame-parallax calculating unit 2, the frame-parallax expanding unit 8, the frame-parallax correcting unit 3, the parallax-adjustment-amount calculating unit 4, and the adjusted-image generating unit 5.

The image input data for left eye Da1 and the image input data for right eye Db1 are input to the image reducing unit 7 and the adjusted-image generating unit 5. The image reducing unit 7 reduces the image input data for left eye Da1 and the image input data for right eye Db1 and outputs image data for left eye Da3 and image data for right eye Db3. The image data for left eye Da3 and the image data for right eye Db3 are input to the parallax calculating unit 1. The parallax calculating unit 1 calculates, based on the image data for left eye Da3 and the image data for right eye Db3, a parallax in each of regions and outputs the parallax as the parallax data T1. The parallax data T1 is input to the frame-parallax calculating unit 2.

The frame-parallax calculating unit 2 calculates, based on the parallax data T1, a parallax with respect to the frame of attention and outputs the parallax as the frame parallax data T2. The frame parallax data T2 is input to the frame-parallax expanding unit 8.

The frame-parallax expanding unit 8 expands the frame parallax data T2 and outputs expanded frame parallax data T8. The expanded frame parallax data T8 is input to the frame-parallax correcting unit 3.

The frame-parallax correcting unit 3 outputs the frame parallax data after correction T3 obtained by correcting the expanded frame parallax data T8 of the frame of attention referring to the expanded frame parallax data T8 of frames at other hours. The frame parallax data after correction T3 is input to the parallax-adjustment-amount calculating unit 4.

The parallax-adjustment-amount calculating unit 4 outputs the parallax adjustment data T4 calculated based on the parallax adjustment information S1 input by the viewer 9 and the frame parallax data after correction T3. The parallax adjustment data T4 is input to the adjusted-image generating unit 5.

The adjusted-image generating unit 5 outputs the image output data for left eye Da2 and the image output data for right eye Db2 obtained by adjusting, based on the parallax adjustment data T4, a parallax between the image data for left eye Da3 and the image data for right eye Db3. The image output data for left eye Da2 and the image output data for right eye Db2 are input to the display unit 6. The display unit 6 displays the image output data for left eye Da2 and the image output data for right eye Db2 on the display surface.

The detailed operations of the image processing apparatus 120 according to the fifth embodiment are explained below.

The image input data for left eye Da1 and the image input data for right eye Db1 are input to the image reducing unit 7. A three-dimensional video includes a moving image formed by continuous pairs of images for left eye and images for right eye. The image input data for left eye Da1 is an image for left eye and the image input data for right eye Db1 is an image for right eye. Therefore, the images themselves of the video are the image input data for left eye Da1 and the image input data for right eye Db1. For example, when the image is a television image, a video signal formed by a decoder decoding a broadcast signal is input as the image input data for left eye Da1 and the image input data for right eye Db1.

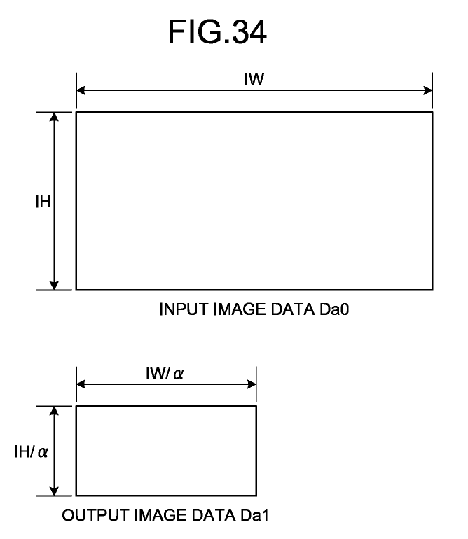

FIG. 34 is a schematic diagram for explaining the image reducing unit 7. The image reducing unit 7 reduces the image input data for left eye Da1 and the image input data for right eye Db1, which are input data, and generates the image data for left eye Da1 and the image data for right eye Db3. When an image size of the input data is set to width IW and height IH and both a horizontal reduction ratio and a vertical reduction ratio are set to 1/α (α>1), an image size of output data from the image reducing unit 7 is width IW/α and height IH/α.

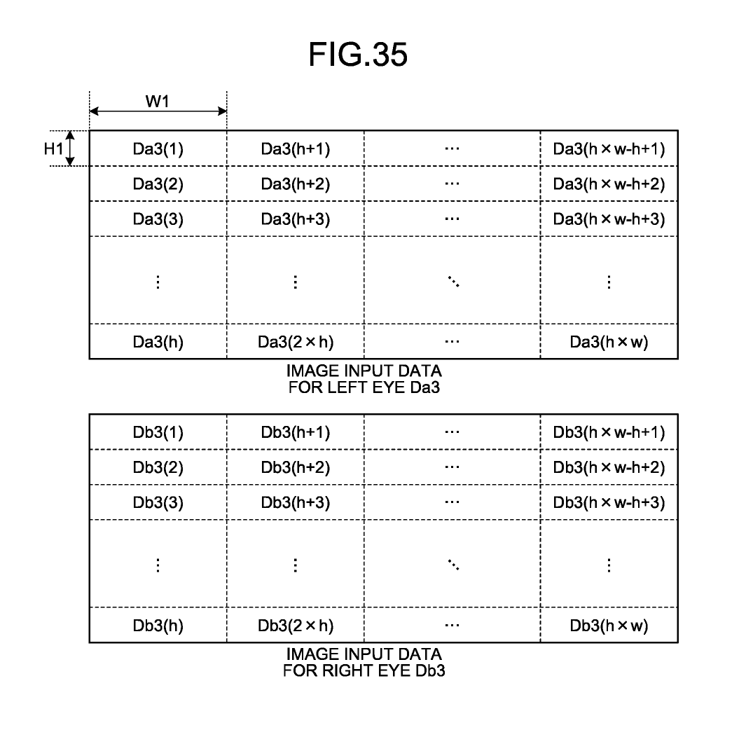

FIG. 35 is a schematic diagram for explaining a method in which the parallax calculating unit 1 calculates, based on the image data for left eye Da3 and the image data for right eye Db3, the parallax data T1.

The parallax calculating unit 1 sections the image data for left eye Da3 and the image data for right eye Db3 into regions having the size of width W1 and height H1 and calculates a parallax amount in each of the regions. When the invention according to the fifth embodiment is implemented in an actual LSI or the like, the number of divisions of a screen is determined taking into account a processing amount and the like of the LSI.

The number of regions in the vertical direction of the sectioned regions is represented as a positive integer h and the number of regions in the horizontal direction is represented as a positive integer w. In FIG. 35, a number of a region at the most upper left is 1 and subsequent regions are sequentially numbered 2 and 3 to h×w. Image data included in the first region of the image input data for left eye Da3 is represented as Da3(1) and image data included in the subsequent regions are represented as Da3(2) and Da3(3) to Da3(h×w). Similarly, image data included in the regions of the image input data for right eye Db3 are represented as Db3(1), Db3(2), and Db3(3) to Db3(h×w).

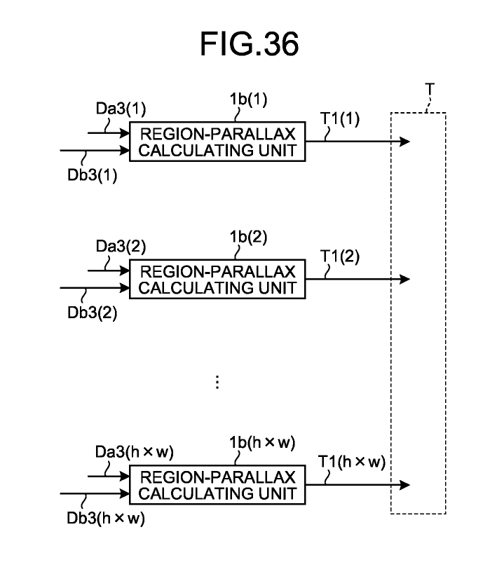

FIG. 36 is a schematic diagram of the detailed configuration of the parallax calculating unit 1. The parallax calculating unit 1 includes h×w region-parallax calculating units 1b to calculate a parallax amount in each of the regions. The region-parallax calculating unit 1b(1) calculates, based on the image data for left eye Da3(1) and the image data for right eye Db3(1) included in the first region, a parallax amount in the first region and outputs the parallax amount as parallax data T1(1) of the first region. Similarly, the region-parallax calculating units 1b(2) to 1b(h×w) respectively calculate parallax amounts in the second to h×w-th regions and output the parallax amounts as parallax data T1(2) to T1(h×w) of the second to h×w-th regions. The parallax calculating unit 1 outputs the parallax data T1(1) to T1(h×w) of the first to h×w-th regions as the parallax data T1.

The region-parallax calculating unit 1b(1) calculates, using a phase limiting correlation method, the parallax data T1(1) between the image data for left eye Da3(1) and the image data for right eye Db3(1). The phase limiting correlation method is explained in, for example, Non-Patent Literature (Mizuki Hagiwara and Masayuki Kawamata “Misregistration Detection at Sub-pixel Accuracy of Images Using a Phase Limiting Function”; the Institute of Electronics, Information and Communication Engineers Technical Research Report, No. CAS2001-11, VLD2001-28, DSP2001-30, June 2001, pp. 79 to 86). The phase limiting correlation method is an algorithm for receiving a pair of images of a three-dimensional video as an input and outputting a parallax amount.

Because explanation concerning the phase limiting correlation method explained using Formulas (1) to (4) in the first embodiment is the same as the explanation in the first embodiment, the explanation is omitted.

In the region-parallax calculating unit 1b, Nₒₚₜ calculated by the phase limiting correlation method with the image data for left eye Da3(1) set as “a” of Formula (4) and the image data for right eye Db3(1) set as “b” of Formula (4) is the parallax data T1(1).

A method of calculating the parallax data T1(1) from the image data for left eye Da3(1) and the image data for right eye Db3(1) included in the first region using the phase limiting correlation method is explained with reference to FIGS. 4(a) to 4(c) in the first embodiment. A characteristic curve represented by a solid line in FIG. 4(a) represents the image data for left eye Da3(1) corresponding to the first region. The abscissa indicates a horizontal position and the ordinate indicates a gradation. A graph of FIG. 4(b) represents the image data for right eye Db3(1) corresponding to the first region. The abscissa indicates a horizontal position and the ordinate indicates a gradation. A characteristic curve represented by a broken line in FIG. 4(a) is obtained by shifting the characteristic curve of the image input data for right eye Db1(1) shown in FIG. 4(b) by the parallax amount n1 in the first region. A graph of FIG. 4(c) represents the phase limiting correlation function G_{ab}(n). The abscissa indicates the variable n of G_{ab}(n) and the ordinate indicates the intensity of correlation.

The phase limiting correlation function G_{ab}(n) is defined by a sequence “a” and a sequence “b” obtained by shifting “a” by τ, which are continuous sequences. The phase limiting correlation function G_{ab}(n) is a delta function having a peak at n=−τ according to Formulas (2) and (3). When the image data for right eye Db3(1) projects with respect to the image data for left eye Da3(1), the image data for right eye Db3(1) shifts in the left direction. When the image data for right eye Db3(1) retracts with respect to the image data for left eye Da3(1), the image data for right eye Db3(1) shifts in the right direction. Data obtained by dividing the image data for left eye Da3(1) and the image data for right eye Db(1) into regions is highly likely to shift in at least one of the projecting direction and the retracting direction. Nₒₚₜ of Formula (1) calculated with the image data for left eye Da3(1) and the image data for right eye Db3(1) set as the inputs a(m) and b(m) of Formula (4) is the parallax data T1(1).

In the fifth embodiment, the parallax data T1 is a value having a sign. The parallax data T1 corresponding to a parallax in a projecting direction between an image for right eye and an image for left eye corresponding to each other is positive. The parallax data T1 corresponding to a parallax in a retracting direction between the image for right eye and the image for left eye corresponding to each other is negative. When there is no parallax between the image for right eye and the image for left eye corresponding to each other, the parallax data T1 is zero.

A shift amount is n1 according to a relation between FIGS. 4(a) and 4(b). Therefore, when the variable n of a shift amount concerning the phase limiting correlation function G_{ab}(n) is n1 as shown in FIG. 4(c), a value of a correlation function is the maximum.

The region-parallax calculating unit 1b(1) outputs, as the parallax data T1(1), the shift amount n1 at which a value of the phase limiting correlation function G_{ab}(n) with respect to the image data for left eye Da3(1) and the image data for right eye Db3(1) is the maximum according to Formula (1).

Similarly, the region-parallax calculating units 1b(2) to 1b(h×w) output, as parallax data T1(2) to parallax data T1(h×w), shift amounts at which values of phase limiting correlations of image data for left eye Da3(2) to Da3(h×w) and image data for right eye Db3(2) to Db3(h×w) included in the second to h×w-th regions are peaks.

Non-Patent Document 1 describes a method of directly receiving the image input data for left eye Da1 and the image input data for right eye Db1 as inputs and obtaining a parallax between the image input data for left eye Da1 and the image input data for right eye Db1. However, as an input image is larger, computational complexity increases, and thus when the method is implemented in an LSI, a circuit size is made large.

The parallax calculating unit 1 of the three-dimensional image display apparatus 220 according to the fifth embodiment divides the image data for left eye Da3 and the image data for right eye Db3 into small regions and applies the phase limiting correlation method to each of the regions. Therefore, the phase limiting correlation method can be implemented in an LSI in a small circuit size. In this case, the circuit size can be further reduced by calculating parallax amounts for the respective regions in order using one circuit rather than simultaneously calculating parallax amounts for all the regions. The frame-parallax calculating unit 2 explained below outputs, based on the parallax amounts calculated for the respective regions, a parallax amount in the entire image between the image data for left eye Da3 and the image data for right eye Db3.

Because the detailed operations of the frame-parallax calculating unit 2 are the same as those explained with reference to FIGS. 5 and 6 in the first embodiment, explanation of the detailed operations is omitted.

The detailed operations of the frame-parallax expanding unit 8 are explained below.

The frame-parallax expanding unit 8 expands the frame parallax data T2 and outputs the expanded frame parallax data T8. When a horizontal reduction ratio in the image reducing unit 7 is represented as 1/α, an expansion ratio in the frame-parallax expanding unit 8 is represented as α. In other words, the expanded frame parallax data T8 is represented as α×T2.

The frame parallax data T2 is a parallax corresponding to the image data for left eye Da3 and the image data for right eye Db3 obtained by reducing the image input data for left eye Da1 and the image input data for right eye Db1 at 1/α. The expanded frame parallax data T8 obtained by multiplying the frame parallax data T2 with α is equivalent to a parallax corresponding to the image input data for left eye Da1 and the image input data for right eye Db1.

The detailed operations of the frame-parallax correcting unit 3 are explained below.

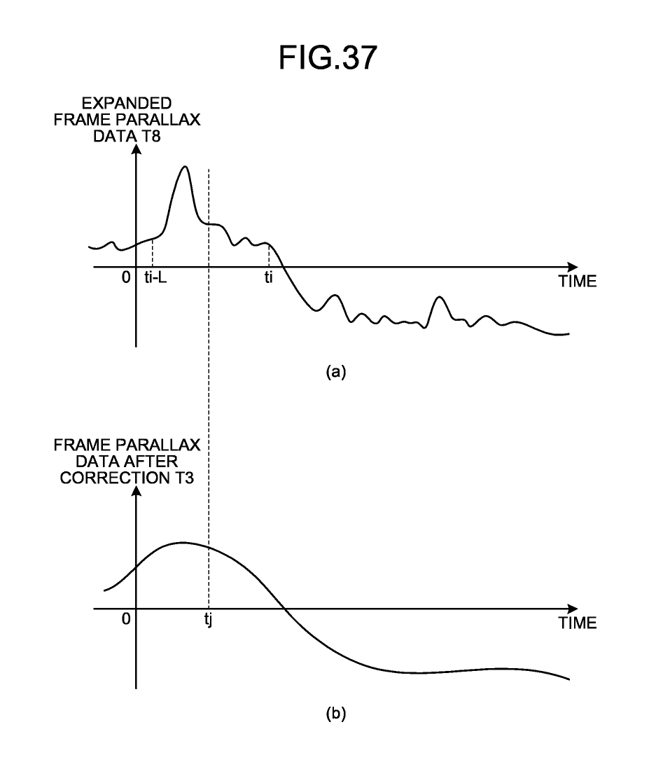

FIG. 37 is a diagram for explaining in detail the frame parallax data after correction T3 calculated from the expanded frame parallax data T8. FIG. 37(a) is a diagram of a temporal change of the expanded frame parallax data T8. The abscissa indicates time and the ordinate indicates the expanded frame parallax data T8. FIG. 37(b) is a diagram of a temporal change of the frame parallax data after correction T3. The abscissa indicates time and the ordinate indicates the frame parallax data after correction T3.

The frame-parallax correcting unit 3 stores the expanded frame parallax data T8 for a fixed time, calculates an average of a plurality of the expanded frame parallax data T8 before and after a frame of attention, and outputs the average as the frame parallax data after correction T3. The frame parallax data after correction T3 is represented by the following Formula (10):

$$T 3 ( tj ) = \frac{{\sum }_{k = ti - L}^{ti} T 8 ( k )}{L} \qquad ( 10 )$$

where, the frame parallax data after correction T3(tj) is frame parallax data after correction at the hour tj of attention. The expanded frame parallax data T8(k) is expanded frame parallax data at the hour k. The positive integer L represents width for calculating an average. Because tj<ti, for example, the frame parallax data after correction T3 at the hour tj shown in FIG. 37(b) is calculated from an average of the expanded frame parallax data T8 from the hour (ti−L) to the hour ti shown in FIG. 37(a). Because (ti−L)<tj<ti, for example, the frame parallax data after correction T3 at the hour tj shown in FIG. 37(b) is calculated from the average of the expanded frame parallax data T8 from the hour (ti−L) to the hour ti shown in FIG. 37(a).

Most projection amounts of a three-dimensional video temporally continuously change. When the expanded frame parallax data T8 temporally discontinuously changes, for example, when the expanded frame parallax data T8 changes in an impulse shape with respect to a time axis, it can be regarded that misdetection of the expanded frame parallax data T8 occurs. Because the frame-parallax correcting unit 3 can temporally average the expanded frame parallax data T8 even if there is the change in the impulse shape, the misdetection can be eased.

The detailed operations of the parallax-adjustment-amount calculating unit 4 are explained below.

The parallax-adjustment-amount calculating unit 4 calculates, based on the parallax adjustment information S1 set by the viewer 9 according to a parallax amount, with which the viewer 9 can easily see an image, and the frame parallax data after correction T3, a parallax adjustment amount and outputs the parallax adjustment data T4.

The parallax adjustment information S1 includes the parallax adjustment coefficient S1a and the parallax adjustment threshold S1b. The parallax adjustment data T4 is represented by the following Formula (11):

$$T 4 = \{ \begin{matrix}0 & ( T 3 \leq S 1 b ) \\ S 1 a \times ( T 3 - S 1 b ) & ( T 3 > S 1 b )\end{matrix} \qquad ( 11 )$$

The parallax adjustment data T4 means a parallax amount for reducing a projection amount according to image adjustment. The parallax adjustment data T4 indicates amounts for horizontally shifting the image input data for left eye Da1 and the image input data for right eye Db1. As explained in detail later, a sum of the amounts for horizontally shifting the image input data for left eye Da1 and the image input data for right eye Db1 is the parallax adjustment data T4. Therefore, when the frame parallax data T3 is equal to or smaller than the parallax adjustment threshold S1b, the image input data for left eye Da1 and the image input data for right eye Db1 are not shifted in the horizontal direction according to the image adjustment. On the other hand, when the frame parallax data after correction T3 is larger than the parallax adjustment threshold S1b, the image data for left eye Da1 and the image data for right eye Db3 are shifted in the horizontal direction by a value obtained by multiplying a difference between the frame parallax data after correction T3 and the parallax adjustment threshold S1b with the parallax adjustment coefficient S1a ((T3−S1b)×S1a).

For example, in the case of the parallax adjustment coefficient S1a=1 and the parallax adjustment threshold S1b=0, T4=0 when T3≦0. In other words, the image adjustment is not performed. On the other hand, T4=T3 when T3>0, and the image data for left eye Da3 and the image data for right eye Db3 are shifted in the horizontal direction by T4. Because the frame parallax data after correction T3 is a maximum parallax of a frame image, a maximum parallax calculated in the frame of attention is 0. When the parallax adjustment coefficient S1a is reduced to be smaller than 1, the parallax adjustment data T4 decreases to be smaller than the parallax data after correction T3 and the maximum parallax calculated in the frame of attention increases to be larger than 0. When the parallax adjustment threshold S1b is increased to be larger than 0, adjustment of the parallax data T1 is not applied to the frame parallax data after correction T3 having a value larger than 0. In other words, parallax adjustment is not applied to a frame in which an image is slightly projected.

For example, a user determines the setting of the parallax adjustment information S1 while changing the parallax adjustment information S1 with input means such as a remote controller and checking a change in a projection amount of the three-dimensional image. The user can also input the parallax adjustment information S1 from a parallax adjustment coefficient button and a parallax adjustment threshold button of the remote controller. However, the predetermined parallax adjustment coefficient S1a and parallax adjustment threshold S1b can be set when the user inputs an adjustment degree of a parallax from one ranked parallax adjustment button.

The image display apparatus 220 can include a camera or the like for observing the viewer 9, discriminate the age of the viewer 9, the sex of the viewer 9, the distance from the display surface to the viewer 9, and the like, and automatically set the parallax adjustment information S1. In this case, the size of a display surface of the image display apparatus 220 and the like can be included in the parallax adjustment information S1. Only predetermined values of the size of the display surface of the image display apparatus 220 and the like can also be set as the parallax adjustment information S1. As explained above, information including personal information, the age of the viewer 9, and the sex of the viewer 9 input by the viewer 9 using the input means such as the remote controller, positional relation including the distance between the viewer 9 and the image display apparatus, and information related to a situation of viewing such as the size of the display surface of the image display apparatus is referred to as information indicating a situation of viewing.

The operation of the adjusted-image generating unit 5 is explained below.

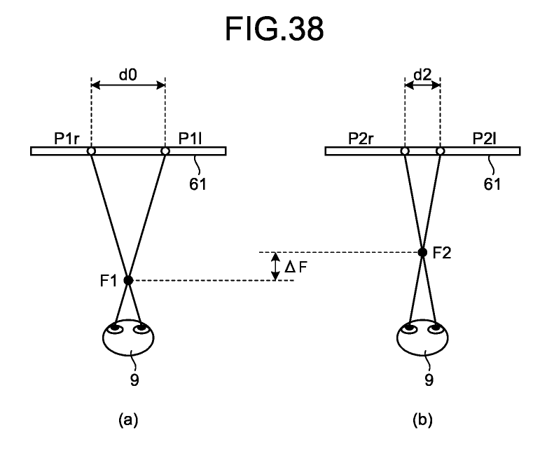

FIG. 38 is a diagram for explaining a relation between a parallax amount between the image input data for left eye Da1 and the image input data for right eye Db1 and a projection amount. FIG. 38 is a diagram for explaining a relation between a parallax amount between the image output data for left eye Da2 and the image output data for right eye Db2 and a projection amount. FIG. 38(a) is a diagram of the relation between the parallax amount between the image input data for left eye Da1 and the image input data for right eye Db1 and the projection amount. FIG. 38(b) is a diagram of the relation between the parallax amount between the image output data for left eye Da2 and the image output data for right eye Db2 and the projection amount.

When the adjusted-image generating unit 5 determines based on the parallax adjustment data T4 that T3>S1b, the adjusted-image generating unit 5 outputs the image output data Da2 obtained by horizontally shifting the image data for left eye Da3 in the left direction based on the parallax adjustment data T4 and outputs the image output data for right eye Db2 obtained by horizontally shifting the image data for right eye Db3 in the right direction. At this point, the parallax amount d2 is calculated as the parallax amount d2=d0−T4 using the parallax amount d0 and the parallax adjustment data T4.

The pixel P1l of the image input data for left eye Da1 and the pixel P1r of the image input data for right eye Db1 are the same part of the same object. A parallax amount between the pixels P1l and P1r is d0. From the viewer 9, the object is seen projected to the position of the position F.

The pixel P21 of the image output data for left eye Da2 and the pixel P2r of the image output data for right eye Db2 are the same part of the same object. A parallax amount between the pixels P21 and P2r is d2. From the viewer 9, the object is seen projected to the position of the position F2.

The image data for left eye Da3 is horizontally shifted in the left direction and the image data for right eye Db3 is horizontally shifted in the right direction. Consequently, the parallax amount d0 decreases to be the parallax amount d2. Therefore, the projecting position of the object changes from the position F1 to the position F2 according to the decrease of the parallax amount d0.

The frame parallax data after correction T3 is calculated from the expanded frame parallax data T8, which is maximum parallax data of an input frame image. Therefore, the frame parallax data after correction T3 is the maximum parallax data of the frame image. The parallax adjustment data T4 is calculated based on the frame parallax data after correction T3 according to Formula (8). Therefore, when the parallax adjustment coefficient S1a is 1, the parallax adjustment data T4 is equal to a maximum parallax amount in the frame of attention. When the parallax adjustment coefficient S1a is smaller than 1, the parallax adjustment data T4 is smaller than the maximum parallax amount. If the parallax amount d0 shown in FIG. 38(a) is assumed to be a maximum parallax amount calculated in the frame of attention, when the parallax adjustment coefficient S1a is set smaller than 1, the maximum parallax amount d2 after adjustment shown in FIG. 38(b) is a value smaller than the parallax amount d0. When the parallax adjustment coefficient S1a is set to 1 and the parallax adjustment threshold S1b is set to 0, a video is an image that is not projected and the parallax amount d2 is 0. Consequently, the maximum projected position F2 of the image data after adjustment is adjusted to a position between the display surface 61 and the projected position F1.

The operation of the display unit 6 is explained below. The display unit 6 displays the image output data for left eye Da2 and the image output data for right eye Db2 separately on the left eye and the right eye of the viewer 9. Specifically, a display system can be a three-dimensional image display system employing a display that can display different images on the left eye and the right eye with an optical mechanism such as a barrier or a lens that limits a display angle. The display system can also be a three-dimensional image display system employing dedicated eyeglasses that alternately close shutters of lenses for the left eye and the right eye in synchronization with a display that alternately displays an image for left eye and an image for right eye.

Consequently, the image processing apparatus 120 according to the fifth embodiment can display a three-dimensional image with a parallax amount between an input pair of image input data Da1 and Db1 changed to a parallax amount for a sense of depth suitable for the viewer 9 corresponding to the distance from the display surface 61 to the viewer 9 and the personal difference of the viewer 9.

The detailed operations of the image display apparatus 220 that displays a three-dimensional image according to the fifth embodiment of the present invention are explained above.

The fifth embodiment is explained below based on a specific image example.

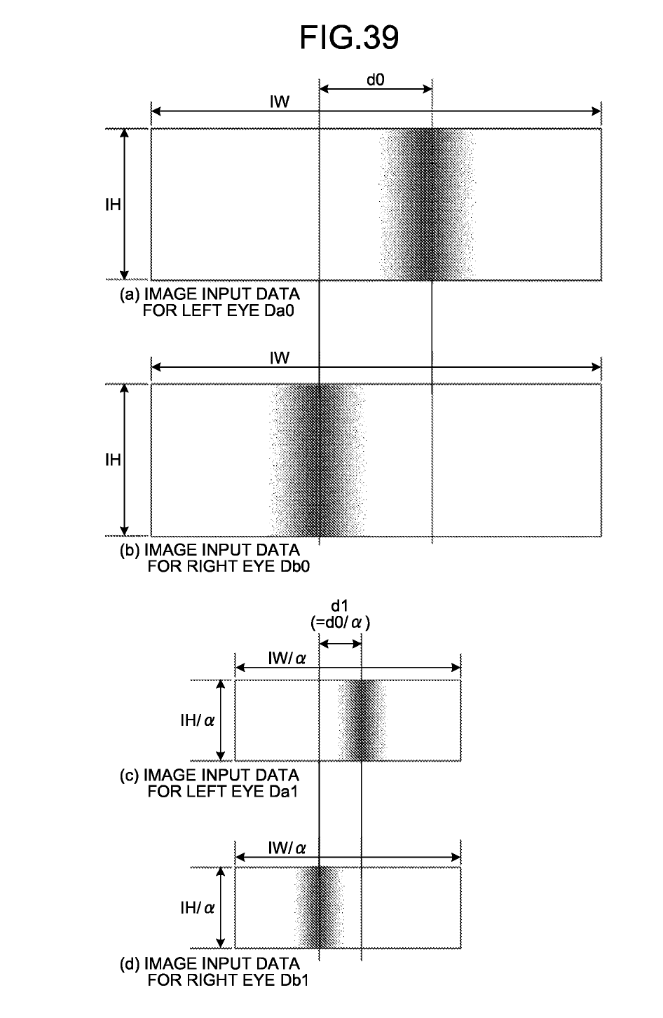

FIG. 39 is a schematic diagram of a specific example of the operation of the image reducing unit 7. FIG. 39(a) is a diagram of the entire image input data for left eye Da1. FIG. 39(b) is a diagram of the entire image input data for right eye Db1. FIG. 39(c) is a diagram of the reduced entire image data for left eye Da3. FIG. 39(d) is a diagram of the entire image input data for right eye Db1. Both a horizontal reduction ratio and a vertical reduction ratio are set to 1/α (α>1). There is a parallax of the parallax amount d0 in the horizontal direction between the image input data for left eye Da1 and the image input data for right eye Db1. At this point, a parallax amount between the reduced image data for left eye Da3 and image data for right eye Db3 is d0/α obtained by dividing the parallax amount d0 by α. The parallax amount between the reduced image data for left eye Da3 and image data for right eye Db3 is represented as d1.

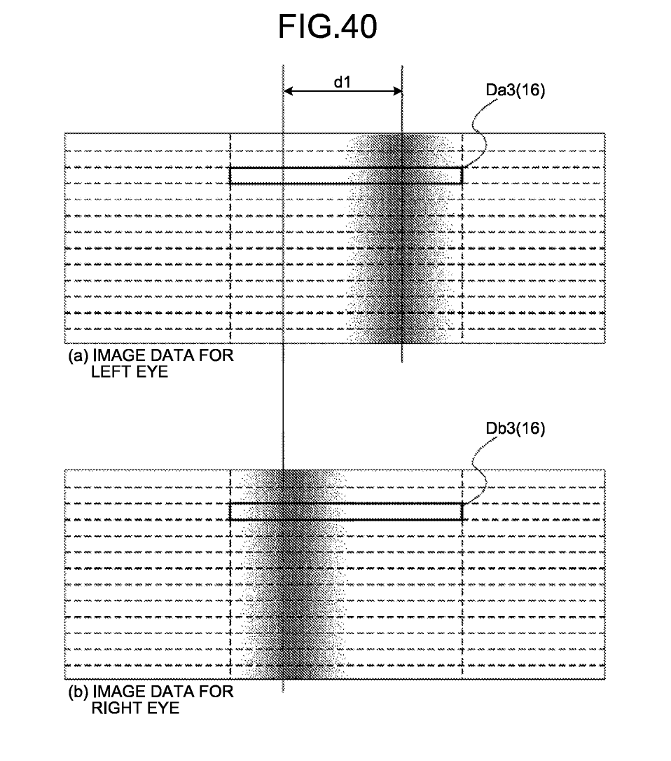

FIG. 40 is a schematic diagram of a specific example of the image data for left eye Da3 and the image data for right eye Db3. FIG. 40(a) is a diagram of the entire image data for left eye Da3. FIG. 40(b) is a diagram of the entire image data for right eye Db3. There is a parallax of the parallax amount d1 in the horizontal direction between the image data for left eye Da3 and the image data for right eye Db3. Boundaries for sectioning the image data for left eye Da3 and the image data for right eye Db3 into regions for calculating a parallax amount are indicated by broken lines. Each of the image data for left eye Da3 and the image data for right eye Db3 is divided into, in order from a region at the most upper left, a first region, a second region, and a third region to a thirty-ninth region at the most lower right. Image data for left eye Da3(16) and image data for right eye Db3(16) in a sixteenth region of attention are indicated by thick solid lines.

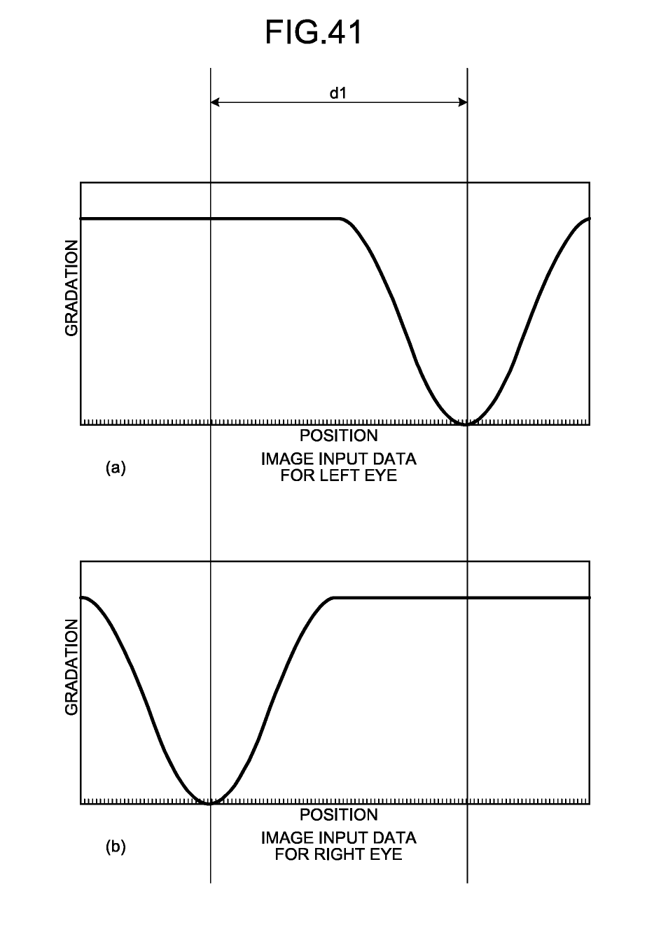

FIG. 41 is a diagram for explaining a method of calculating a parallax amount from the image data for left eye Da3(16) and the image data for right eye Db3(16). FIG. 41(a) is a diagram of a relation between a horizontal position and a gradation of the image data for left eye Da3(16). FIG. 41(b) is a diagram of a relation between a horizontal position and a gradation of the image data for right eye Db3(16). The abscissa indicates the horizontal position and the ordinate indicates the gradation.

Both the image data for left eye Da3(16) and the image data for right eye Db3(16) are represented as graphs including regions that change in a convex trough shape in a direction in which the gradation decreases. Positions of minimum values of the image data for left eye Da3(16) and the image data for right eye Db3(16) shift exactly by the parallax amount d1. The image data for left eye Da3(16) and the image data for right eye Db3(16) are input to the region-parallax calculating unit 1b(16) of the parallax calculating unit 1. The parallax amount d1 is output as the parallax data T1(16) of the sixteenth region.

Because explanation concerning the sectioning of the parallax data T1, which is output by the parallax calculating unit 1, by the region-parallax calculating unit 1b is the same as the explanation made with reference to FIG. 11 in the first embodiment, the explanation is omitted. Because explanation concerning the calculation of the frame parallax data T2 from the parallax data T1 is the same as the explanation made with reference to FIG. 12 in the first embodiment, the explanation is omitted.

The frame-parallax expanding unit 8 multiplies the frame parallax data T2 output by the frame-parallax calculating unit 2 with α and outputs the expanded frame parallax data T8. Because a parallax amount of the frame parallax data T2 is d1, a parallax amount of the frame parallax data T3 is d0.

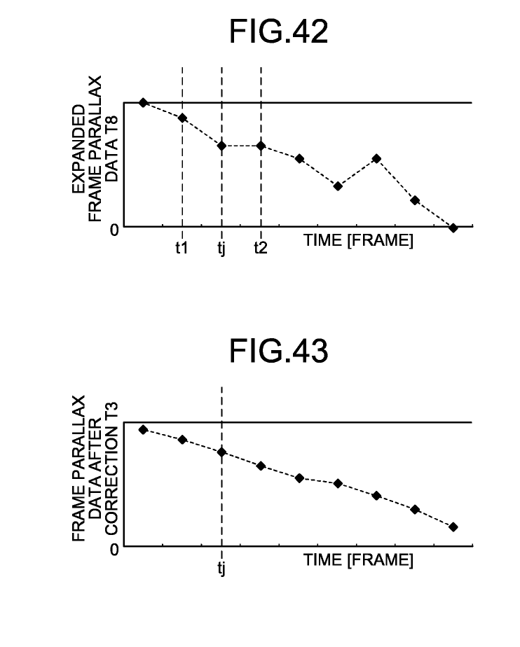

FIG. 42 is a schematic diagram of a temporal change of the expanded frame parallax data T8 output by the frame-parallax expanding unit 8. In FIG. 42, the abscissa indicates time and the ordinate indicates the expanded frame parallax data T8. The image shown in FIGS. 39(a) and 39(b) is a frame at the time tj.

FIG. 43 is a diagram for explaining a method of calculating the frame parallax data after correction T3 from the expanded frame parallax data T8. A temporal change of the frame parallax data after correction T3 is shown in FIG. 43. In FIG. 43, the abscissa indicates time and the ordinate indicates the frame parallax data after correction T3. The image shown in FIG. 39 is a frame at the time tj. The frame-parallax correcting unit 3 averages the expanded frame parallax data T8 of the frame of attention and the frames before and after the frame of attention using Formula (5). The frame-parallax correcting unit 3 outputs an average of the expanded frame parallax data T8 as the frame parallax data after correction T3. For example, the frame parallax data after correction T3(tj) at the hour tj in FIG. 43 is calculated as an average of expanded frame parallax data T8(t1), T8(tj), and T8(t2) at the hours t1, tj, and t2 shown in FIG. 42. In other words, T3(tj)=(T8(t1)+T8(tj)+T8(t2))/3.

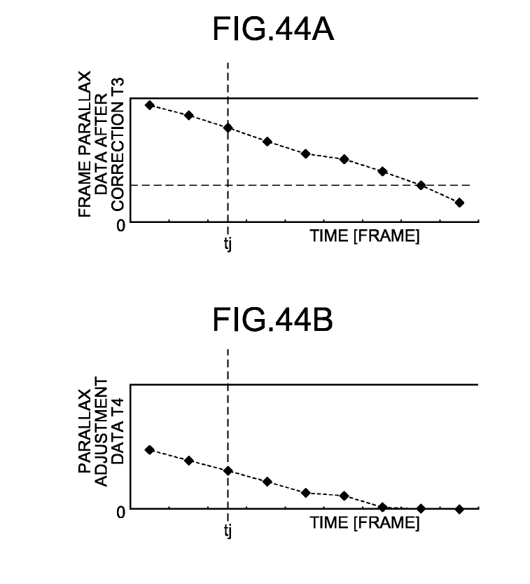

FIGS. 44A and 44B are diagrams for explaining a method of calculating the parallax adjustment data T4 from the frame parallax data after correction T3. FIG. 44A is a diagram of a temporal change of the frame parallax data after correction T3. S1b represents a parallax adjustment value. FIG. 44B is a diagram of a temporal change of the parallax adjustment data T4. In FIGS. 44A and 44B, the abscissa indicates time and the ordinate indicates the parallax adjustment data T4.

The parallax-adjustment-amount calculating unit 4 outputs, based on the frame parallax data after correction T3 shown in FIG. 44A, the parallax adjustment data T4 shown in FIG. 44B. The parallax-adjustment-amount calculating unit 4 outputs 0 as the parallax adjustment data T4 at an hour when the frame parallax data after correction T3 is equal to or smaller than the parallax adjustment threshold S1b. The hour when the frame parallax data after correction T3 is equal to or smaller than the first parallax adjustment threshold S1b is an hour when an image is not projected much. Conversely, in a hour when the frame parallax data after correction T3 is larger than the first parallax adjustment threshold S1b, a value obtained by multiplying an excess amount of the frame parallax data after correction T3 over the first parallax adjustment threshold S1b with the parallax adjustment coefficient S1a ((T3−S1b))×S1a) is output as the parallax adjustment data T4.

Calculation of the image output data for left eye Da2 and the image output data for right eye Db2 from the parallax adjustment data T14, the image input data for left eye Da1, and the image input data for right eye Db1 is explained with reference to FIG. 16 in the first embodiment. FIG. 16 is a diagram of a frame at the hour tj same as the image shown in FIG. 40. FIG. 16(a) is a diagram of the image output data for left eye Da2. FIG. 16(b) is a diagram of the image output data for right eye Db2.

The adjusted-image generating unit 5 horizontally shifts, based on the parallax adjustment data T4 at the time tj shown in FIG. 44B, the image input data for left eye Da1 to the left by T4/2, which is a half value of the parallax adjustment data T4. The adjusted-image generating unit 5 horizontally shifts the image input data for right eye Db1 to the right by T4/2, which a half value of the parallax adjustment data T4. The adjusted-image generating unit 5 outputs the respective image data as the image output data for left eye Da2 and the image output data for right eye Db2. In the fifth embodiment, the parallax amount d2 shown in FIG. 16 is d0−T5 and is reduced compared with the parallax amount d0.

As explained above, the image display apparatus 220 according to the fifth embodiment controls a projection amount by reducing a parallax amount of an image having a large projection amount exceeding a threshold. Consequently, the image display apparatus 220 can display a three-dimensional image with the parallax amount changed to a parallax amount for a suitable sense of depth corresponding to the distance from the display surface 61 to the viewer 9 and the individual difference of the viewer 9.

In the example explained in the fifth embodiment, the frame-parallax correcting unit 3 calculates an average of a plurality of the frame parallax data T2 before and after the frame of attention and outputs the average as the frame parallax data after correction T3. However, the frame-parallax correcting unit 3 can calculate a median of a plurality of the frame parallax data T2 before and after the frame of attention and output the median as the frame parallax data after correction T3. The frame-parallax correcting unit 3 can calculate, using other methods, a value obtained by correcting a plurality of the frame parallax data T2 before and after the frame of attention and output the frame parallax data after correction T3.

Data input to the parallax calculating unit 1 at the time when the image reducing unit 7 does not perform image reduction processing and data input to the parallax calculating unit 1 at the time when the image reducing unit 7 performs the image reduction processing are compared. When the image reducing unit 7 does not perform the image reduction processing, input image data is directly input to the parallax calculating unit 1. When the image reducing unit 7 performs the image reduction processing, reduced image data is input to the parallax calculating unit 1. It is assumed that the sizes of regions divided by the parallax calculating unit 1 are the same. In this case, when images included in the regions divided by the parallax calculating unit 1 are compared, a wider range can be referred to if a reduced image is used. Therefore, a large parallax can be detected. Because the number of divided regions is small if the reduced image is used, computational complexity decreases and responsiveness is improved. Therefore, a circuit size for performing image processing can be reduced if the reduced image is used.

### Sixth Embodiment

An image processing method for the image processing apparatus 120 explained in the fifth embodiment is explained. The parallax-calculating step ST1 is explained with reference to FIG. 18 in the first embodiment. The frame-parallax correcting step ST3 is explained with reference to FIG. 19 in the first embodiment.

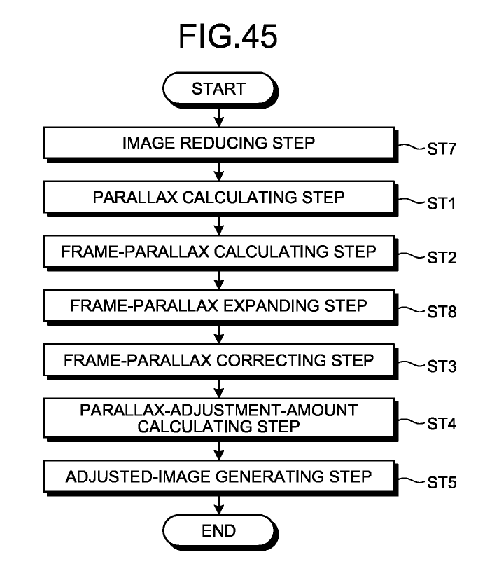

FIG. 45 is a flowchart for explaining a flow of an image processing method for a three-dimensional image according to a sixth embodiment of the present invention. The three-dimensional image processing method according to the sixth embodiment includes an image reducing step ST7, the parallax calculating step ST1, the frame-parallax calculating step ST2, a frame-parallax expanding step ST8, the frame-parallax correcting step ST3, the parallax-adjustment-amount calculating step ST4, and the adjusted-image generating step ST5.

The parallax calculating step ST1 includes the image slicing step ST1a and the region-parallax calculating step ST1b as shown in FIG. 18.

The frame-parallax correcting step ST3 includes the frame-parallax buffer step ST3a and the frame-parallax arithmetic means step ST3b as shown in FIG. 19.

The operation in the sixth embodiment of the present invention is explained below.

First, at the image reducing step ST7, the image input data for left eye Da1 and the image input data for right eye Db1 are reduced and the image data for left eye Da3 and the image data for right eye Db3 are output. This operation is the same as the operation by the image reducing unit 7 in the fifth embodiment.

At the parallax calculating step ST1, processing explained below is applied to the image data for left eye Da3 and the image data for right eye Db3.

At the image slicing step ST1a, the image data for left eye Da3 is sectioned in a lattice shape having width W1 and height H1 and divided into h×w regions on the display surface 61. The divided image data for left eye Da3(1), Da3(2), and Da3(3) to Da1(h×w) are created. Similarly, the image data for right eye Db3 is sectioned in a lattice shape having width W1 and height H1 to create the divided input data for right eye Db3(1), Db3(2), and Db3(3) to Db3(h×w).

At the region-parallax calculating step ST1b, the parallax data T1(1) of the first region is calculated with respect to the image data for left eye Da3(1) and the image data for right eye Db3(1) for the first region using the phase limiting correlation method. Specifically, the variable n of an amount at which the phase limiting correlation G_{ab}(n) is the maximum is calculated with respect to the image data for left eye Da3(1) and the image data for right eye Db3(1) and is set as the parallax data T1(1). The parallax data T1(2) to T1(h×w) are calculated with respect to the image data for left eyes Da3(2) to Da3(h×w) for the second to h×w-th regions using the phase limiting correlation method. The parallax data T1(2) to T1(h×w) are also calculated with respect to the image data for right eye Db3(2) to Db3(h×w) using the phase limiting correlation method. This operation is the same as the operation by the parallax calculating unit 1 in the fifth embodiment.

At the frame-parallax calculating step ST2, maximum parallax data among the parallax data T1(1) to T1(h×w) is selected and set as the frame parallax data T2. This operation is equivalent to the operation by the frame-parallax calculating unit 2 in the fifth embodiment.

At the frame-parallax expanding step ST8, the frame parallax data T2 is expanded and the expanded frame parallax data T8 is output. This operation is the same as the frame-parallax calculating unit 4 in the fifth embodiment.

At the frame-parallax correcting step ST3, processing explained below is applied to the expanded frame parallax data T8.

At the frame-parallax buffer step ST3a, the temporally changing expanded frame parallax data T8 is sequentially stored in a buffer storage device having a fixed capacity.

At the frame-parallax arithmetic mean step ST3b, an arithmetic mean of a plurality of the expanded frame parallax data before and after the frame of attention is calculated based on the expanded frame parallax data T8 stored in a buffer region and the frame parallax data after correction T3 is calculated. This operation is equivalent to the operation by the frame-parallax correcting unit 3 in the fifth embodiment.

At the parallax-adjustment-amount calculating step ST4, based on the parallax adjustment coefficient S1a and the parallax adjustment threshold S1b set in advance, the parallax adjustment data T4 is calculated from the frame parallax data after correction T3. At an hour when the frame parallax data after correction T3 is equal to or smaller than the parallax adjustment threshold S1b, the parallax adjustment data T4 is set to 0 (T4=0). Conversely, at an hour when the frame parallax data after correction T3 exceeds the parallax adjustment threshold S1b, a value obtained by multiplying an excess amount of the frame parallax data after correction T3 over the parallax adjustment threshold S1b with the parallax adjustment coefficient S1a is set as the parallax adjustment data T4 (T4=S1a×(T3a−S1b)). This operation is the same as the operation by the parallax-adjustment-amount calculating unit 4 in the fifth embodiment.

At the adjusted-image generating step ST5, based on the parallax adjustment data T4, the image output data for left eye Da2 and the image output data for right eye Db2 are calculated from the image data for left eye Da3 and the image data for right eye Db3. Specifically, the image data for left eye Da3 is horizontally shifted in the left direction by T4/2, which is a half value of the parallax adjustment data T4. The image data for right eye Db3 is horizontally shifted in the right direction by T4/2, which is a half value of the parallax adjustment data T4. Consequently, the image output data for left eye Da2 and the image output data for right eye Db2 with the parallax amount reduced by the parallax adjustment data T4 are generated. This operation is the same as the operation by the adjusted-image generating unit 5 in the fifth embodiment.

The operation of the three-dimensional image processing method according to the sixth embodiment of the present invention is as explained above.

According to the above explanation, the image processing method according to the sixth embodiment is the same as the three-dimensional image processing apparatus 120 according to the fifth embodiment. Therefore, the image processing method according to the sixth embodiment has effects same as those of the image processing apparatus according to the fifth embodiment of the present invention.

In the above explanation, the expansion processing is applied to the frame parallax data T2 in the frame-parallax correcting unit 3 in the fifth embodiment and at the frame-parallax correcting step ST3 in the sixth embodiment. However, the expansion processing is not limited to the examples in the fifth and sixth embodiments. The expansion processing can be applied to any one of the parallax data T1, the frame parallax data after correction T3, and the parallax adjustment data T4 for each of regions.

According to the present invention, it is possible to reduce recognition of a double image by a viewer irrespective of whether parallax information is embedded in a three-dimensional video.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a parallax calculating unit that receives input of a pair of image input data forming a three-dimensional video, divides the pair of image input data into a plurality of regions, calculates a parallax amount corresponding to each of the regions, and outputs the parallax amount as parallax data corresponding to each of the regions;
a frame-parallax calculating unit that generates, based on a plurality of the parallax data, frame parallax data and outputs the frame parallax data;
a frame-parallax correcting unit that corrects frame parallax data of one frame based on frame parallax data of other frames and outputs the frame parallax data as frame parallax data after correction;
a parallax-adjustment-amount calculating unit that generates, based on parallax adjustment information created based on information indicating a situation of viewing and the frame parallax data after correction, parallax adjustment data and outputs the parallax adjustment data; and
an adjusted-image generating unit that generates a pair of image output data, a parallax amount of which is adjusted based on the parallax adjustment data, and outputs the image output data.

2. The image processing apparatus according to claim 1, wherein the frame parallax data is generated based on parallax data in a projecting direction among the parallax data.

3. The image processing apparatus according to claim 2, wherein the frame parallax data is the parallax data of a maximum value among the parallax data.

4. The image processing apparatus according to claim 1, wherein the parallax adjustment data is generated by correcting, based on a threshold set based on the parallax adjustment information and a coefficient set based on the parallax adjustment information, the frame parallax data after correction.

5. The image processing apparatus according to claim 4, wherein, when the frame parallax data after correction is large with reference to the threshold, the parallax adjustment data is a value obtained by multiplying a difference between the frame parallax data after correction and the threshold with the coefficient and, when the frame parallax data after correction is small with reference to the threshold, a value of the parallax adjustment data is set to zero.

6. The image processing apparatus according to claim 1, wherein the frame parallax data after correction is an average of the frame parallax data of the one frame and frame parallax data before and after the one frame.

7. The image processing apparatus according to claim 1, wherein the frame parallax data includes first frame parallax data and second frame parallax data, the first frame parallax data is generated based on parallax data in a projecting direction among the parallax data, and the second frame parallax data is generated based on parallax data in a retracting direction among the parallax data.

8. The image processing apparatus according to claim 7, wherein the frame-parallax correcting unit corrects the first frame parallax data of the one frame based on the first frame parallax data of the other frames and outputs the first frame parallax data as first frame parallax data after correction, and corrects the second frame parallax data of the one frame based on the second frame parallax data of the other frames and outputs the second frame parallax data as second frame parallax data after correction.

9. The image processing apparatus according to claim 8, wherein the frame-parallax correcting unit outputs, as the first frame parallax data after correction, an average of the first frame parallax data of the one frame and the first frame parallax data before and after the one frame and outputs, as the second frame parallax data after correction, an average of the second frame parallax data of the one frame and the second frame parallax data before and after the one frame.

10. The image processing apparatus according to claim 7, wherein the parallax adjustment data is generated by correcting, based on a threshold set based on the parallax adjustment information and a coefficient set based on the parallax adjustment information, the frame parallax data after correction.

11. The image processing apparatus according to claim 10, wherein
the threshold includes a first threshold, and
the parallax-adjustment-amount calculating unit outputs, when the first frame parallax data after correction is larger than the first threshold, as the parallax adjustment data, a value obtained by multiplying the first frame parallax data after correction with the coefficient.

12. The image processing apparatus according to claim 11, wherein,
the threshold further includes a second threshold, and
the parallax-adjustment-amount calculating unit outputs, when the first frame parallax data after correction is larger than the first threshold and a value obtained by subtracting a value obtained by multiplying the first frame parallax data after correction with the coefficient from the second frame parallax data after correction is smaller than the second threshold, as the parallax adjustment data, a value smaller than a value obtained by multiplying the first frame parallax data after correction with the coefficient.

13. The image processing apparatus according to claim 12, wherein the parallax-adjustment-amount calculating unit outputs, when the second frame parallax data after correction is smaller than the second threshold, a value zero as the parallax adjustment data.

14. The image processing apparatus according to claim 1, further comprising:
an image reducing unit that receives input of the pair of image input data, reduces the pair of image input data, and outputs a pair of reduced image data; and
a frame-parallax expanding unit that expands the frame parallax data and outputs the frame parallax data to the frame-parallax correcting unit as expanded frame parallax data, wherein
the parallax calculating unit divides the pair of reduced image data into a plurality of regions, calculates a parallax amount corresponding to each of the regions, and outputs the parallax amount as parallax data corresponding to each of the regions.

15. The image processing apparatus according to claim 1, wherein the adjusted-image generating unit generates a pair of image output data obtained by shifting image input data of the pair of image input data in a direction for reducing a parallax amount by a half amount of the parallax adjustment data.

16. An image display apparatus comprising a display unit in the image processing apparatus, wherein the image processing apparatus comprises:
a parallax calculating unit that receives input of a pair of image input data forming a three-dimensional video, divides the pair of image input data into a plurality of regions, calculates a parallax amount corresponding to each of the regions, and outputs the parallax amount as parallax data corresponding to each of the regions;
a frame-parallax calculating unit that generates, based on a plurality of the parallax data, frame parallax data and outputs the frame parallax data;
a frame-parallax correcting unit that corrects frame parallax data of one frame based on frame parallax data of other frames and outputs the frame parallax data as frame parallax data after correction;
a parallax-adjustment-amount calculating unit that generates, based on parallax adjustment information created based on information indicating a situation of viewing and the frame parallax data after correction, parallax adjustment data and outputs the parallax adjustment data; and
an adjusted-image generating unit that generates a pair of image output data, a parallax amount of which is adjusted based on the parallax adjustment data, and outputs the image output data, and
wherein the display unit displays a pair of image output data generated by the adjusted-image generating unit.

17. An image processing method comprising:
receiving input of a pair of image input data forming a three-dimensional video, dividing the pair of image input data into a plurality of regions, calculating a parallax amount corresponding to each of the regions, and outputting the parallax amount as parallax data corresponding to each of the regions;
generating, based on the parallax data, frame parallax data and outputting the frame parallax data;
correcting frame parallax data of one frame based on frame parallax data of other frames, generating frame parallax data after correction, and outputting the frame parallax data after correction;
generating, based on parallax adjustment information created based on information indicating a situation of viewing and the frame parallax data after correction, parallax adjustment data and outputting the parallax adjustment data; and
generating a pair of image output data, a parallax amount of which is adjusted based on the parallax adjustment data, and outputting the image output data.

18. The image processing method according to claim 17, wherein the frame parallax data includes first frame parallax data and second frame parallax data, the first frame parallax data is generated based on parallax data in a projecting direction among the parallax data, and the second frame parallax data is generated based on parallax data in a retracting direction among the parallax data.

19. The image processing method according to claim 17, further comprising the steps of:
receiving input of the pair of image input data, reducing the pair of image input data, and outputting a pair of reduced image data; and
expanding the frame parallax data and outputting the frame parallax data to the step of correcting frame-parallax data as expanded frame parallax data, wherein
the step of calculating a parallax amount includes dividing the pair of reduced image data into a plurality of regions, calculating a parallax amount corresponding to each of the regions, and outputting the parallax amount as parallax data corresponding to each of the regions.
